(19) United States
(12) Patent Application Publication
(10) Pub. No.: US 2015/0227166 A1
(43) Pub. Date: Aug. 13, 2015

(54) USER TERMINAL DEVICE AND DISPLAYING METHOD THEREOF

(71) Applicant: SAMSUNG ELECTRONICS CO., LTD., Suwon-si (KR)

(72) Inventors: Yong-yeon LEE, Suwon-si (KR); Yun-kyung KIM, Suwon-si (KR); Jae-yeon RHO, Seoul (KR); Hae-yoon PARK, Seoul (KR); Ji-yeon KWAK, Seoul (KR)

(73) Assignee: SAMSUNG ELECTRONICS CO., LTD., Suwon-si (KR)

(21) Appl. No.: 14/621,656

(22) Filed: Feb. 13, 2015

Related U.S. Application Data
(60) Provisional application No. 61/939,380, filed on Feb. 13, 2014.

(30) Foreign Application Priority Data
Jul. 28, 2014 (KR) 10-2014-0095989

(51) Int. Cl. G06F 1/16; G06F 3/0484; G06F 3/0488; G06F 3/041

(52) U.S. Cl. CPC G06F 1/169; G06F 3/0412; G06F 3/0416; G06F 3/04845; G06F 3/0488

(57) ABSTRACT

A user terminal device including: a display; a bezel housing the display, the bezel comprising a plurality of sides; a first touch detector configured to detect a first touch interaction on the display; a second touch detector configured to detect a second touch interaction on the bezel; and a controller configured to, in response to the second touch detector detecting the second touch interaction comprising one or more touch inputs on at least two sides of plurality of sides of the bezel, control the user terminal device to perform a function corresponding to a type of the one or more touch inputs and a position of the touched at least two sides.

### CROSS-REFERENCE TO RELATED APPLICATION

This application claims priority from Korean Patent Application No. 10-2014-0095989, filed on Jul. 28, 2014, in the Korean Intellectual Property Office, and U.S. Provisional Application No. 61/939,380, filed on Feb. 13, 2014, in the United States Patent and Trade Office, the disclosures of which are incorporated herein by reference in their entireties.

### BACKGROUND

1. Field

Methods and apparatuses consistent with one or more exemplary embodiments relate to a user terminal device and a displaying method thereof, and more particularly, to a user terminal device capable of receiving a user's touch input into a display and a bezel which houses the display and a displaying method thereof.

2. Description of the Related Art

With the development of electronic technologies, various kinds of user terminal devices have been developed. Recently, a size of a user terminal device is minimized, and functionality increases, and, thus, a user's demand for the user terminal device is increased.

According to a user's demand, the user terminal device may provide various functions such as a multimedia content player, various application screens, and the like. A user may select a function which the user wants to use by using a button, a touch screen and the like equipped on the user terminal device. The user terminal device may execute a program selectively according to an interaction with a user, and display the execution result.

As the functions provided by a user terminal device become more varied, there arise various needs for content displaying methods and user interaction methods. In other words, as a method for displaying content is changed, and the kinds and function of the content are increased, it is insufficient to use a conventional interaction method, such as selecting a button, or touching a touch screen.

Accordingly, there is an increasing need for a user interaction technology which is used for a user terminal device with a more convenient method.

### SUMMARY

An aspect of one or more exemplary embodiments provides a user terminal device capable of providing various functions according to a touch interaction which is detected in at least one between a display unit or a bezel unit, and a method thereof.

Also, another aspect of one or more exemplary embodiments provides a user terminal device capable of providing various functions according to a touch interaction which touches at least two sides of the bezel unit.

A user terminal device includes a display; a bezel housing the display, the bezel including a plurality of sides; a first touch detector configured to detect a first touch interaction on the display; a second touch detector configured to detect a second touch interaction on the bezel; and a controller configured to, in response to the second touch detector detecting the second touch interaction including one or more touch inputs on at least two sides of plurality of sides of the bezel, control the user terminal device to perform a function corresponding to a type of the one or more touch inputs and a position of the touched at least two sides.

The controller may be further configured to, while an image content is displayed and in response to the second touch detector detecting the second touch interaction including a first touch input on a first side of the plurality of sides and, contemporaneously, a second touch input on a second side of the plurality of sides, the second side adjoining the first side, control the display to display information corresponding to the image content on an area of the display corresponding to an area where the first side and the second side adjoin.

The controller may be further configured to, in response to the second touch detector detecting the second touch interaction including a first touch input onto a first side of the plurality of sides and, contemporaneously, a second touch input onto a second side of the plurality of sides, the second side adjoining the first side, control the display to display notification information corresponding to an area of the display corresponding to an area where the first side and the second side adjoin.

The controller may be further configured to, while an execution screen of a first application is displayed on the display and in response to the second touch detector detecting the second touch interaction including a first touch input onto a first side of the plurality of sides and, contemporaneously, a second touch input onto a second side of the plurality of sides, the second side adjoining the first side, control the display to divide the display into first and second areas based on a line connecting a location of the first touch input and a location of the second touch input, to display the execution screen of the first application on the first area, and to display an execution screen of a second application on the second area.

The controller may be further configured to: while a picture content is displayed on the display and in response to the second touch detector detecting the second touch interaction including a drag input on a first side of the plurality of sides toward a second side of the plurality of sides, the second side adjoining the first side, control the display to display a zoomed-in image of the picture content; and while a picture content is displayed on the display and in response to the second touch detector detecting the second touch interaction including a drag input on the first side toward a third side of the plurality of sides, the third side adjoining the first side at a different location from where the second side adjoins the first side, control the display to display a zoomed-out image of the picture content.

The controller may be further configured to, while a picture content is displayed on the display and in response to the second touch detector detecting the second touch interaction including a first drag input on a first side of the plurality of sides and, contemporaneously, a second drag input on a second side of the plurality of sides not adjoining the first side, the first and second drag inputs being both in either a clockwise or counter-clockwise direction, control the display to rotate the picture content.

The controller may be further configured to, while an execution screen of a first application is displayed and in response to the second touch detector detecting the second touch input including a first swipe input on a first side of the plurality of sides and, contemporaneously, a second swipe input on a second side of the plurality of sides, the second side adjoining the first side, control the display to display an execution screen of a second application on a first area of the execution screen of the first application corresponding to the first and second swipe inputs.

The controller may be further configured to, while a display screen of the display is divided into first and second areas, where an execution screen of a first application is displayed on the first area and an execution screen of a second application is displayed on the second area, and in response to the second touch detector detecting the second touch interaction including a touch input on a first side of the plurality of sides which is adjacent to the first area and a drag input on a second side of the plurality of sides which is adjacent to the second area, control the display to remove the execution screen of the second application from the second area and display on the second area an execution screen of a third application.

According to another exemplary embodiment, there is provided a displaying method of a user terminal device capable of receiving inputting a touch input on a display and on a bezel which houses the display, the bezel including a plurality of sides, the displaying method includes: displaying an image on the display; and performing, in response to detecting a touch interaction including one or more touch inputs on at least two sides of the plurality of sides of the bezel unit, a function of the user terminal device corresponding to a type of the one or more touch inputs and a position of the touched at least two sides.

The performing may include displaying, in response to detecting a first touch input on a first side of the plurality of sides and, contemporaneously, a second touch input on a second side of the plurality of sides while an image content is displayed, the second side adjoining the first side, information corresponding to the image content on an area of the display corresponding to an area where the first side and the second side adjoin.

The performing may include displaying, in response to detecting a first touch input on a first side of the plurality of sides and, contemporaneously a second touch input on a second side of the plurality of sides, the second side adjoining the first side, notification information corresponding to an area of the display corresponding to an area where the first side and the second side adjoin.

The performing may include, in response to detecting a first touch input on a first side of the plurality of sides and, contemporaneously, a second touch input on a second side of the plurality of sides while a first application is executed, the second side adjoining the first side, dividing the display into first and second areas based on a line connecting a location of the first touch input and a location of the second touch input, displaying an execution screen of the first application on the first area, and displaying an execution screen of a second application on the second area.

The performing may include, in response to detecting a drag input on a first side of the plurality of sides toward a second side of the plurality of sides, the second side adjoining the first side, while a picture content is displayed, zooming-in the picture content; and in response to detecting a drag input on the first side toward a third side of the plurality of sides, the third side adjoining the first side at a different location from where the second side adjoins the first side while a picture content is displayed, zooming-out the picture content.

The performing may include, in response to detecting a drag input on a first side of the plurality of sides and, contemporaneously, a second drag input on a second side of the plurality of sides not adjoining the first side while a picture content is displayed, the first and second drag inputs being both in either a clockwise or counter-clockwise direction, rotating the picture content.

The performing may include, in response to detecting a swipe input on a first side of the plurality of sides and, contemporaneously, a second swipe input on a second side of the plurality of sides while a first application is executed, the second side adjoining the first side, displaying an execution screen of a second application on a first area of an execution screen of the first application of the first application corresponding to the first and second swipe inputs.

The performing may include, while a display screen of the display is divided into first and second areas, where an execution screen of a first application is displayed on the first area and an execution screen of a second application is displayed on the second area, and in response to detecting a touch input on a first side of the plurality of sides which is adjacent to the first area and a drag input on a second side of the plurality of sides which is adjacent to the second area, removing the execution screen of the second application from the second area and displaying an execution screen of a third application.

According to another exemplary embodiment, a user terminal device includes: a display; a bezel housing the display, the bezel including a plurality of sides; a first touch detector configured to detect a first touch interaction on the display; a second touch detector configured to detect a touch interaction on the bezel; and a controller configured to, in response to the first touch detector detecting the first touch interaction including a first touch input on the display, control the user terminal device to perform a first function, and, in response to the second touch detector detecting the second touch interaction including a second touch input on the bezel, the second touch input being of a same type as the first touch input, control the user terminal device to perform a second function.

The controller may be further configured to, while an image displayed on an execution screen of a gallery application is displayed on the display, in response to the first touch detector detecting the first touch interaction including a drag input on the display, control the display to change the displayed execution screen based on a file unit, and, in response to the second touch detector detecting the second touch interaction including a drag input on the bezel, control the display to change the displayed execution screen based on a folder unit.

The controller may be further configured to, while an execution screen of an e-book application is displayed, in response to the first touch detector detecting the first touch interaction including a drag input on the display, control the display to change the displayed execution screen based on a page unit, and, in response to the second touch detector detecting the second touch interaction including a drag input on the bezel, control the display to change the displayed execution screen based on a chapter unit.

The controller may be further configured to, while an execution screen of a first application is displayed on a display screen if the display, in response to the first touch detector detecting the first touch interaction including a drag input on the display, control the display to scroll the execution screen of the first application, and, in response to the second touch detector detecting the second touch interaction including a drag input on the bezel, control the display to remove a portion of the execution screen of the first application from a portion of the display screen and display a portion of an execution screen of a second application on the portion of the display screen.

The controller may be further configured to, while a picture content is displayed on the display, in response to the first touch detector detecting the first touch interaction including a pinch-in touch input, where two touch points move closer together, on the display, control the display to display a zoomed-out image of the picture content, and, in response to the second touch detector detecting the second touch interaction including a pinch-in touch input one the bezel, control the display to display a folder list, the image content being within a folder among folders of the folder list.

According to another exemplary embodiment, there is provided a displaying method of a user terminal device configured to receive a touch input on a display and a bezel which houses the display, the bezel including a plurality of sides, the displaying method includes: displaying an image on the display; and in response to detecting a first touch input on the display, performing a first function of the user terminal device, and, in response to detecting a second touch input on the bezel, the second touch input being of a same type as the first touch input, performing a second function of the user terminal device.

The performing may include, in response to detecting a drag input on the display while an execution screen of a gallery application is displayed, changing the execution screen based on a file unit, and in response to detecting a drag interaction in the bezel unit while the execution screen of the gallery application is displayed, changing the execution screen based on to a folder unit.

The performing may include, in response to detecting a drag input on the display while an execution screen of an e-book application is displayed, changing the execution screen based on a page unit, and in response to detecting a drag input on the bezel unit while an execution screen of an e-book application is displayed, changing the execution screen based on a chapter unit.

The performing may include, in response to detecting a drag input on the display while an application screen of a first application is displayed, scrolling the execution screen of the first application, and in response to detecting a drag input on the bezel unit while an application screen of a first application is displayed, removing a portion of the execution screen of the first application from a portion of a display screen of the display, and displaying a portion of an execution screen of a second application.

The performing may include, in response to detecting a pinch-in touch input, where two touch points move closer together, on the display while a picture content is displayed, zooming out the picture content, and in response to detecting the pinch-in touch input on the bezel unit while a picture content is displayed, displaying a folder list, the picture content being within a folder among folders of the folder list.

According to another exemplary embodiment, a user terminal device includes: a display; a bezel housing the display; a touch detector configured to detect a touch input on the bezel; a hinge unit connected to at least one of the bezel and the display, the hinge unit configured to enable the terminal device to fold in half; and a controller configured to, in response to the touch detector detecting a touch input on the bezel while the terminal device is folded in half, control the user terminal device to perform a first function corresponding to a state of the terminal device.

The user terminal device may further include: a communication interface configured to send and receive voice calls; and an audio input/out (I/O) interface configured to output an audio signal. The controller may be further configured to, in response to touch detector detecting a touch input on the bezel while the terminal device is folded in half and while the communication interface is receiving a request for a voice call, control the communication interface to establish a call connection and to control the audio I/O to output audio data corresponding to the voice call.

The user terminal device may further include a communication interface configured to send and receive written messages; and an audio input/out (I/O) interface configured to output an audio signal. The controller may be further configured to, in response to touch detector detecting a touch input on the bezel while the terminal device is folded in half and while the communication interface has received a new message, perform text-to-speech conversion on the new message creating new message audio data, and to control the audio I/O interface to output the new message audio data.

According to various exemplary embodiments described above, by touching at least one among a display and a bezel unit, a user may perform various functions of a user terminal device.

### BRIEF DESCRIPTION OF THE DRAWINGS

FIG. 1 is a block diagram illustrating a configuration of a user terminal device according to an exemplary embodiment;

FIG. 2 is a block diagram illustrating a configuration of a user terminal device according to an exemplary embodiment;

FIGS. 3A to 3E are views illustrating a user terminal device including a bezel unit which is capable of detecting a touch interaction according to an exemplary embodiment;

FIG. 4 is a view illustrating a configuration of software stored in a storage according to an exemplary embodiment;

FIGS. 5A to 14B are views illustrating various functions of a user terminal according to a touch interaction according to one or more exemplary embodiment;

FIGS. 15A to 30 are views illustrating various functions of a user terminal according to a touch interaction according to various exemplary embodiments;

FIGS. 31A and 31B are views illustrating a function of a user terminal according to a touch interaction which touches a bezel while a user terminal device is completely folded according to one or more exemplary embodiment;

FIGS. 32A to 35 are views illustrating a function mapped onto a bezel being controlled when a user terminal device is rotated according to various exemplary embodiment; and

FIGS. 36 and 37 are flowcharts illustrating a method for displaying on a user terminal device according to various exemplary embodiments.

### DETAILED DESCRIPTION OF THE EXEMPLARY EMBODIMENTS

In the following description, the same drawing reference numerals are used for the same elements even in different drawings. The matters defined in the description, such as detailed construction and elements, are provided to assist in a comprehensive understanding of one or more exemplary embodiments. Thus, it is apparent that the exemplary embodiments can be carried out without those specifically defined matters. Also, well-known functions or constructions are not described in detail since they would obscure the exemplary embodiments with unnecessary detail.

Although the terms first, second, etc. may be used herein to describe various elements, these elements should not be limited by these terms. These terms are only used to distinguish one element from another element.

The terminology used herein is for the purpose of describing particular exemplary embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

In one or more exemplary embodiments, a “module” or a “unit” may perform at least one function or operation and may be embodied as hardware or software or as a combination of hardware and software. Also, a plurality of “modules” or a plurality of “units” may be integrated into at least one module. A “module” or a “unit” may be embodied as a particular hardware configuration, or may be embodied by at least one processor.

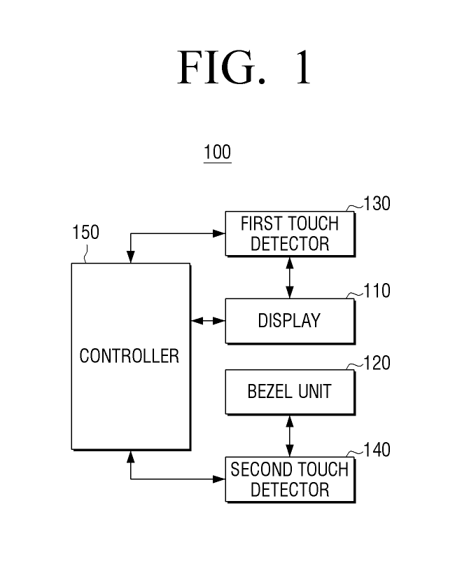

Hereinafter, exemplary embodiments are described in greater detail with reference to the accompanying drawings. FIG. 1 is a block diagram illustrating a configuration of a user terminal device 100 according to an exemplary embodiment. As illustrated in FIG. 1, the user terminal device 100 includes a display 110, a bezel unit 120, i.e. a bezel, a first touch detector 130, a second touch detector 140, and a controller 150. Herein, the user terminal device 100 may be realized as various kinds of devices such as a television (TV), a personal computer (PC), a laptop computer, a cellular phone, a tablet PC, a personal digital assistant (PDA), an MP3 player, a kiosk, an electronic picture frame, a table display device and the like. When the user terminal device 100 is realized as a portable device such as a cellular phone, a tablet PC, a PDA, an MP3 player, a laptop computer and the like, it may be called a mobile device, but may also be referred to a user terminal device.

The display 110 displays various kinds of image data and user interfaces (UI). The display 110 may be combined with the first touch detector 130 and be realized as a touch screen. Also, the display 110 may be bended at a bending line corresponding to one or more hinges.

The bezel unit 120 is located on a border of the display 110, and houses the display 110. The bezel unit 120 may include the second touch detector 140.

The first touch detector 130 detects a touch interaction of a user which is inputted to the display 110. The second touch detector 140 detects a touch interaction of a user which is inputted to the bezel unit 120.

The controller 150 controls an overall operation of the user terminal device 100 according to a touch interaction detected by the first touch detector 130 and the second touch detector 140. For example, in response to detecting a first touch interaction, i.e. a touch input or a touch, on the display 110 through the first touch detector 130, the controller 150 performs a first function of the user terminal device 100. Also, in response to detecting a second touch interaction which is an identical or similar type as the first touch interaction but on the bezel unit 120 through the second touch detector 140, the controller 150 may perform a second function of the user terminal device 100. In other words, the controller 150 may perform a different function according to an area where a touch interaction is detected even if an identical or similar type of touch interaction is detected.

For example, in response to detecting a drag interaction through the second touch detector 140, the controller 150 may convert a screen to a higher level screen as compared to detecting a drag interaction through the first touch detector 130.

For example, in response to detecting a drag interaction though the first touch detector 130 while a gallery application is executed, the controller 150 may control the display 110 to convert the display screen based on a file unit. However, in response to detecting a drag interaction through the second touch detector 140, the controller 150 may control the display 110 to convert the display screen based on a folder unit.

In response to detecting the first touch detector 130 while an e-book application is executed, the controller 150 may control the display to convert a display screen based on a page unit. Also, in response to detecting a drag interaction through the second touch detector 140, the controller 150 may control the display 110 to convert a display screen based on a chapter unit.

In response to detecting a drag interaction through the first touch detector 130, the controller 150 may change a screen within an application, but in response to detecting a drag interaction through the second touch detector 140, the controller 140 may convert an execution screen among a plurality of applications.

For example, in response to detecting a drag interaction through the first touch detector 130 while a first application is executed, the controller 150 may control the display 110 to scroll an execution screen of the first application. Also, in response to detecting a drag interaction through the second touch detector 140, the controller 150 may control the display 110 to remove at least a part of an execution screen of the first application from a display screen, and display at least a part of an execution screen of a second application.

In response to detecting a pinch-in interaction where a distance between two touched points becomes closer through the first touch detector 130 while a picture content is displayed, the controller 150 may control the display 110 to zoom out of the picture content, and in response to detecting the pinch-in interaction through the second touch detector 140, the controller 150 may control the display 110 to display a folder list.

In response to detecting a touch interaction which touches at least two sides of the bezel unit 120 through the second touch detector 140, the controller 150 may perform a function of the user terminal device 100 corresponding to a type of the touch interaction and the touched at least two sides.

For example, in response to detecting a touch interaction which simultaneously or contemporaneously touches the first side of the bezel unit 120 and the second side of the bezel unit 120 which adjoins the first side while an image content is displayed, the controller 150 may control the display 110 to display information regarding the image content on a corner area which is between the points where the first side and the second side are touched.

In response to detecting a touch interaction which simultaneously touches the first side of the bezel unit 120 and the second side of the bezel unit 120 which adjoins the first side, the controller 150 may control the display 110 to display notification information (for example, received message information, missed call information, update information and the like) of a user terminal device on a corner area which is between points where the first side and the second side are touched.

In response to detecting a touch interaction which simultaneously touches the first side of the bezel unit 120 and the third side of the bezel unit 120 which is located on an opposite side of the bezel as the first side while the first application is executed, the controller 150 may control the display 110 to divide the display 110 into two areas according to a line which connects points on the first side and the third side of the bezel which are touched simultaneously, to display an execution screen of the first application on the first area, and to display an execution screen of the second application on the second area. Herein, the second application may be an application related to the first application. For example, when the first application is a telephone application, the second application may be a memo application or a calendar application which is related to the telephone application.

In response to detecting a drag interaction from the first side of the bezel unit 120 to the second side of the bezel unit 120 which adjoins the first side while a picture content is displayed, the controller 150 may control the display 110 to zoom in the picture content, and in response to detecting a drag interaction from the first side of the bezel unit 120 to a fourth side of the bezel which adjoins the first side, the controller 150 may control the display 110 to zoom out the picture content. Herein, an amount of the zoom-in or a zoom-out may be based on a number of sides of the bezel unit 120 where the drag interaction is detected or a length of the drag interaction.

In response to detecting a drag interaction simultaneously in opposite direction on the first side of the bezel unit 120 and the third side of the bezel unit 120 which is located opposite the first side while a picture content is displayed, the controller 150 may control the display 110 to rotate the picture content. Herein, a rotation direction of the picture content may be decided based on the direction of drag interaction.

In response to detecting a swipe interaction which simultaneously swipes the first side of the bezel unit 120 and the second side of the bezel unit 120 which adjoins the first side while the first application is executed, the controller 150 may control the display 110 to display an execution screen of the second application on the first area of an execution screen of the first application according to the swipe interaction.

While a display screen is divided into two areas where the first and second applications executing on respective first and second areas, in response to a touch interaction which touches the first side which is contacted with the first area, and detects a touch interaction which drags the second side which is contacted with the second area, the controller 150 may control the display 110 to remove an execution screen of the second application from the second area and to display an execution screen of a third application.

As described above, according to various exemplary embodiments, a user may be provided various functions of the user terminal device 100 according to the touch interaction detected on the bezel unit 120.

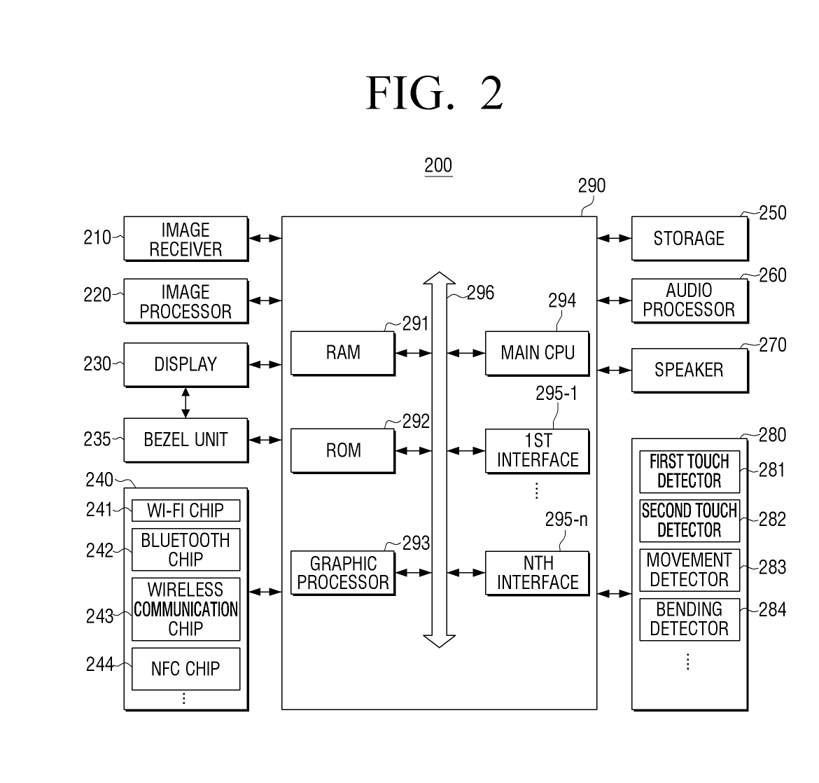

Hereinafter, with reference to FIGS. 2 to 32, one or more exemplary embodiments will be explained in greater detail.

FIG. 2 is a block diagram illustrating a configuration of the user terminal device 200 according to an exemplary embodiment. As illustrated in FIG. 2, the user terminal device 200 includes an image receiver 210, an image processor 220, a display 230, a bezel unit 235, a communicator 240, i.e., a communication interface or a transceiver, a storage 250, i.e., a memory, an audio processor 260, a speaker 270, i.e., an audio input/output (I/O) interface, a detector 280, and a controller 290.

FIG. 2 illustrates various elements of the user terminal device 200 equipped with various functions such as a function of providing content, a display function, and the like according to one or more exemplary embodiments. However, according to one or more exemplary embodiments a one or more elements illustrated in FIG. 2 may be omitted or changed, or other elements may be added.

The image receiver 210 receives an image data through various sources. For example, the image receiver 210 may receive broadcasting data from an external broadcasting company, receive video on demand (VOD) data from an external server in real time, and receive image data from an external apparatus.

The image processor 220 is an element which performs a process regarding image data received from the image receiver 210. The image processor 220 may perform various image processes such as decoding, scaling, noise filtering, frame rate conversion, resolution conversion, and the like.

The display 230 displays at least one among a video frame where image data received from the image receiver 210 is processed by the image processor 220 and various screens generated from the graphic processor 293. According to an exemplary embodiment, the display 230 may be realized as a flexible display which is capable of folding, but this is only an example, and it may be realized as other displays.

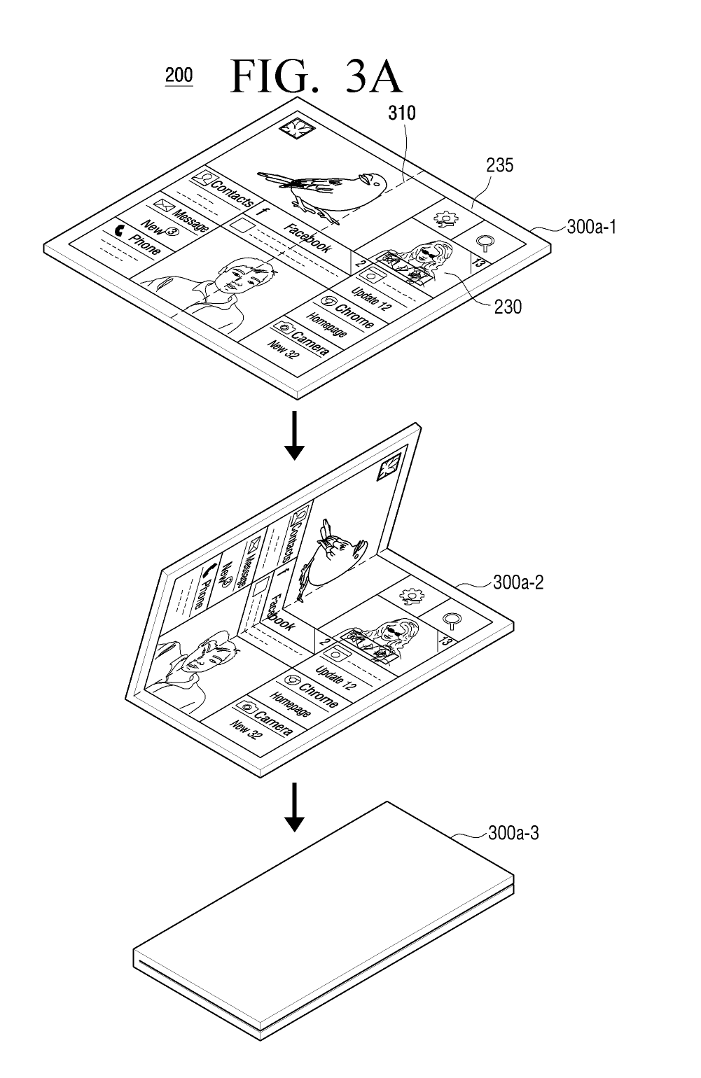

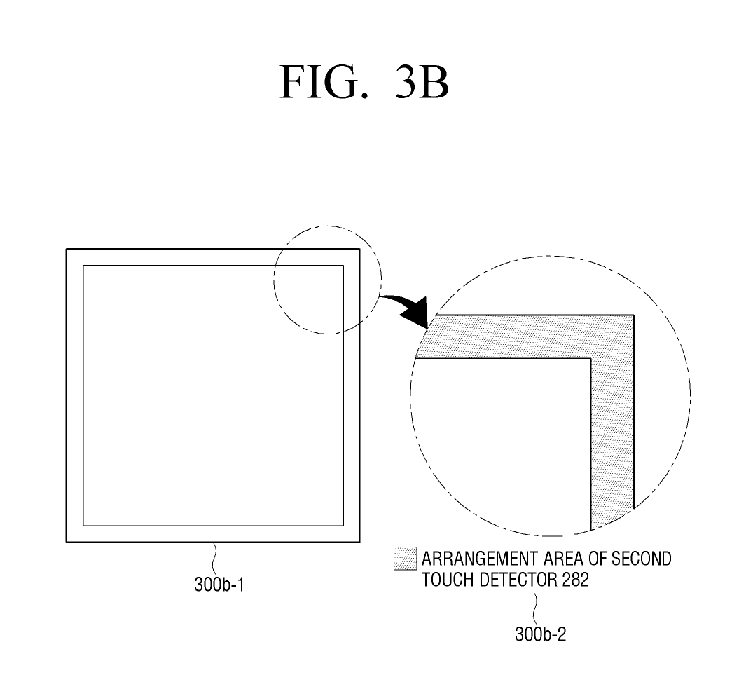

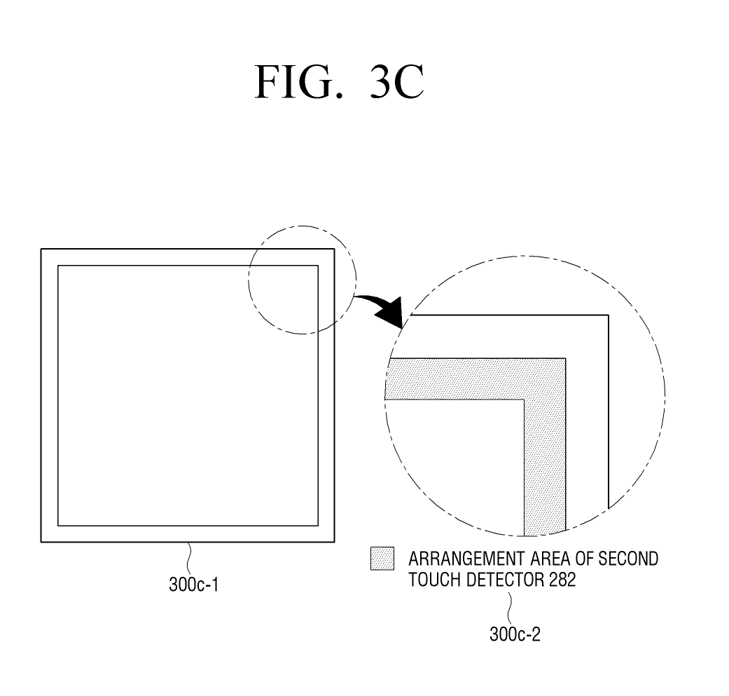

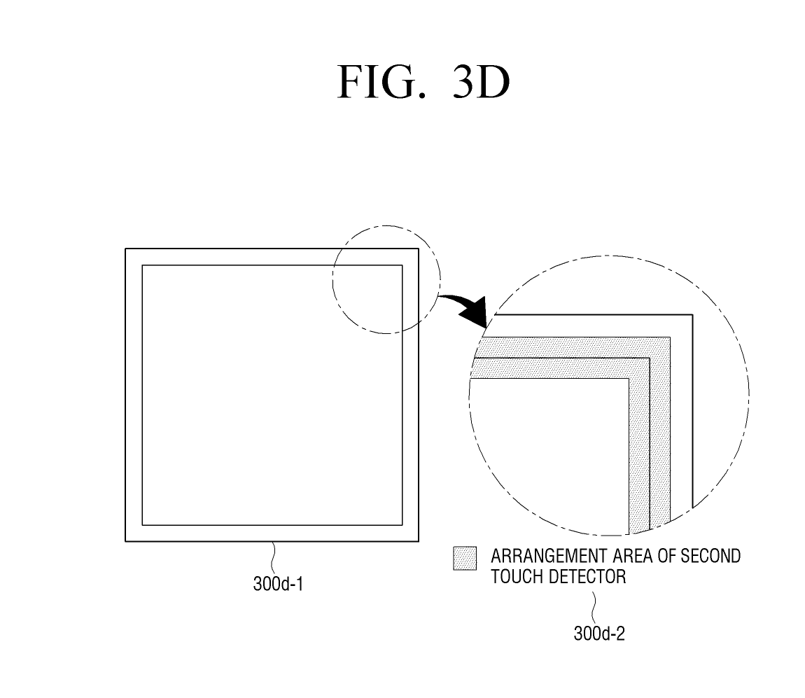

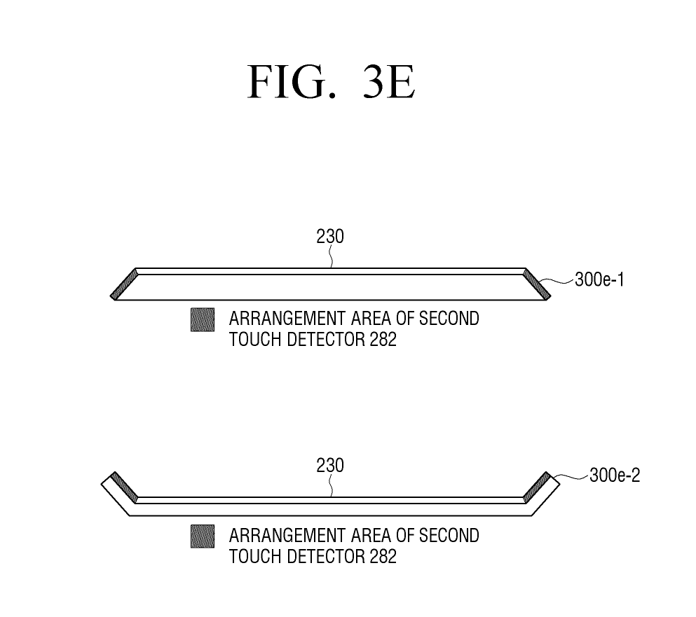

The bezel unit 235 is located on a border of the display 230, and houses the display 230. For example, as illustrated in 300a-1 of FIG. 3A, the bezel unit 235 may be located on a border of the four sides of the display 230. Also, as illustrated in 300a-2 FIG. 3A, the display 230 and the bezel unit 235 may be folded along a folding line 310. Herein, the folding line 310 may be a line around which the user terminal is folded by a hinge unit. The display 230 may be capable of folding completely in half along the folding line 310, as illustrated in 300a-3 of FIG. 3A,

The communicator 240 is configured to perform a communication with various kinds of external apparatuses according to various kinds of communication methods. The communicator 240 includes a Wi-Fi chip 241, a Bluetooth chip 242, a wireless communication chip 243, and a near field communication (NFC) chip 244. The controller 290 performs a communication with various external apparatuses using the communicator 240.

The Wi-Fi chip 241 and the Bluetooth chip 242 perform a communication with a Wi-Fi method and a Bluetooth method, respectively. When the Wi-Fi chip 241 or the Bluetooth chip 242 are used, various kinds of connection information such as a service set identifier (SSID), a session key and the like may be firstly transmitted and received so that a communication connection is established, and then various kinds of information may be transmitted and received. The wireless communication chip 243 means a chip which performs a communication according to various communication standards, such as an Institute of Electrical and Electronics Engineers (IEEE), a Zigbee, the 3rd Generation (3G), the 3rd Generation Partnership Project (3GPP), a Long Term Evolution (LTE), and the like standards. The NFC chip 244 means a chip which is operated by an NFC method using, for example, the frequency of 13.56 MHz among various radio-frequency identification (RF-ID) frequency ranges such as the 135 kHz, 13.56 MHz, 433 MHz, 860-960 MHz, 2.45 GHz frequencies, and the like.

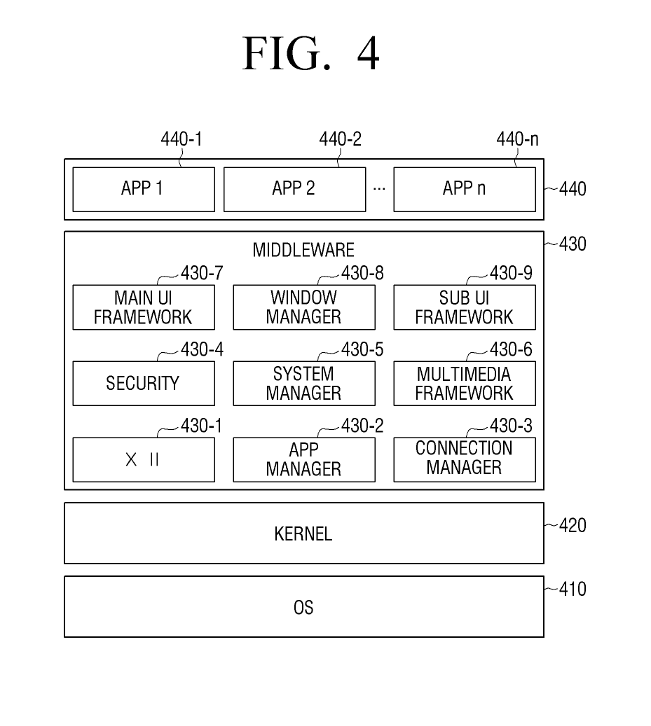

The storage 250 may store various programs and data which are necessary to operate the user terminal device 200. For example, the storage 250 may store a program or data and the like for composing various screens which are displayed on a main area and a sub area. FIG. 4 is a view illustrating an exemplary configuration of software stored in the user terminal device 200. Referring to FIG. 4, the storage 250 may store software including an operation system (OS) 410, a kernel 420, a middleware 430, an application 440, and the like.

The OS 410 performs a function of controlling and managing an overall operation of hardware. In other words, the OS 410 takes charge of basic function such as hardware management, memory management, security, and the like.

The kernel 420 is a channel which conveys various signals including a touch signal detected on the display 230 to the middleware 430.

The middleware 430 includes various software modules which control an operation of the user terminal device 200. Referring to FIG. 4, the middleware 430 includes an X11 module 430-1, an app manager 430-2, a connection manager 430-3, a security module 430-4, a system manager 430-5, a multimedia framework 430-6, a UI framework 430-7, a window manager 430-8, and a sub UI framework module 430-9.

The X11 module 430-1 is a module which receives various event signals from various hardware equipped on the user terminal device 200. Herein, an event may be set variously such as an event which detects a user's gesture, an event where a system alarm occurs, an event where a specific program is executed or ended, and the like.

The app manager 430-2 is a module which manages an execution condition of various applications 440 installed in the storage 250. When an application execution event is detected from the X11 module 430-1, the app manager 430-2 calls and executes an application corresponding to the event.

The connection manager 430-3 is a module which supports a wire or wireless network connection. The connection manager 430-3 may include various detailed modules such as a DNET module, an UPnP module and the like.

The security module 430-4 is a module which supports a certification, a permission, a secure storage, and the like regarding the hardware.

The system manager 430-5 monitors the condition of one or more elements in the user terminal device 200, and provides the monitoring result to other modules. For example, when the remaining battery is insufficient, when an error occurs, when a communication connection is broken, or the like, the system manager 430-5 may provide the monitoring result to the main UI framework 430-7 or the sub UI framework 430-9, and output a notification message or a notification sound.

The multimedia framework 430-6 is a module for playing a multimedia content which is stored in the user terminal device 200 or provided from an external source. The multimedia framework 430-6 may include a player module, a camcorder module, a sound process module and the like. Accordingly, an operation which plays various multimedia contents, and generates and displays a screen and a sound may be performed.

The main UI framework 430-7 is a module for providing various user interfaces (UIs) which are displayed in a main area of the display 230, and the sub UI framework 430-9 is a module for providing various UIs which are displayed in a sub area of the display 230. The main UI framework 430-7 and the sub UI framework 430-9 may include an image compositor module which composes various objects, a coordinate synthesizer which calculates a coordinate where an object is displayed, a rendering module which renders the composed object to the calculated coordinate, a 2D/3D UI toolkit which provides tools for developing and rendering a UI in, for example, two or three dimensions.

The window manager 430-8 may detect a touch event using a user's body or a pen, or other input event. When these events are detected, the window manager 430-8 conveys an event signal to the main UI framework 430-7 or the sub UI framework 430-9, and performs an operation corresponding to an event.

When a user touches or drags a screen, various program modules such as a writing module for drawing line according to a path of drag, an angle calculation module for calculating a pitch angle, a roll angle, a yaw angle and the like based on a sensor value detected by a movement detector 283 may be stored.

An application module 440 includes applications 440-1˜440-n for supporting various functions. For example, a program module for providing various services such as a navigation program module, a game module, an e-book module, a calendar module, a notification management module and the like may be included. These applications may be installed as a default, or a user may install and use these applications. When an object is selected, a main CPU 294 may execute an application corresponding to a selected object using the application module 440.

The configuration of software illustrated in FIG. 4 is merely an example, and is non-limiting. Accordingly, one or more elements may be omitted, changed, or added. For example, the storage may additionally include various programs such as a sensing module for analyzing signals sensed by various sensors, a messaging module such as a messenger program, a short message service (SMS) and multimedia message service (MMS) program, an e-mail program, a call info aggregator program module, a VoIP module, a web browser module, and the like.

Referring to FIG. 2, the audio processor 260 performs a process regarding audio data. The audio processor 260 may perform various processes such as decoding, amplifying, noise filtering and the like regarding audio data. The audio data processed by the audio processor may be outputted to speaker 270.

The speaker 270 is configured to output various kinds of audio data where various process operations such as decoding, amplifying or noise filtering are performed by the audio processor 260, and also various notification sounds and voice messages. Although the speaker 270 is illustrated, this is a non-limiting example. One or more exemplary embodiments may include an audio outputter realized as an output terminal which outputs audio data.

The detector 280 detects various user interactions. For example, as illustrated in FIG. 2, the detector 280 may include a first touch detector 281, a second touch detector 282, a movement detector 283, and a bending detector 284.

The first touch detector 281 may detect a touch interaction of a user using a touch panel attached to the back side of a display panel. The second touch detector 282 may be located in the bezel unit 235 and detect a touch interaction of a user. Herein, the first touch detector 281 may be realized as a touch sensor using a blackout method or a compression method, and the second touch sensor 282 may be realized as a touch sensor using a proximity method. However, these are merely examples, and the first touch detector 281 and the second touch detector 282 may be realized as various touch sensors.

The second touch detector 282 may be located in most or all of the areas of the bezel unit 235, but this is merely an example, and it may be located in only a partial area of the bezel unit 235 (for example, one or more a corner areas).

As illustrated in FIG. 3B, the second touch detector 282 may be located only in a bezel unit 235, but this is only an example. As illustrated in FIG. 3C, the second touch detector 282 may be located on the border of the display 230 adjoining the bezel unit 235, and as illustrated in FIG. 3D, the second touch detector 282 may be located in both the bezel unit 235 and the display 230. When the display 230 is a flexible display, as illustrated in FIG. 3E, the second touch detector 282 may be located in an area which is different in elevation from the display 230.

The movement detector 283 may detect a movement (for example, a rotational movement, etc.) of the user terminal device 200 using at least one of an acceleration sensor, a magnetic sensor and a gyro sensor. The bending detector 284 may detect whether the user terminal device 200 is folded and detect at least one of the folded angles based on a bending line using a bending sensor, an illuminance sensor and the like. Herein, the bending detector 283 may be located on a folding line.

The controller 290 controls an overall operation of the user terminal device 200 using various programs stored in the storage 250.

As illustrated in FIG. 2, the controller 290 includes a RAM 291, ROM 292, a graphic processor 293, a main CPU 294, the first to nth interfaces (295-1˜295-n), and a bus 296. Herein, the RAM 291, the ROM 292, the graphic processor 293, the main CPU 294, first to nth interfaces 295-1˜295-n and the like may be connected to each other through the bus 296.

An instruction set for a system booting and the like is stored in the ROM 292. If a turn-on instruction is input and a power is supplied, the main CPU 294 copies an OS stored in the storage to the RAM 291 according to an instruction stored in the ROM 292, executes the OS, and boots up the system. If the booting is completed, the main CPU 294 copies various application programs stored in the storage 250 to the RAM 291, executes the application program which are copied to the RAM 291, and performs various operations.

The graphic processor 293 generates a screen including various objects such as an item, an image, a text and the like using a calculation unit and the rendering unit. The calculation unit calculates an attribute value such as a coordinate value, a shape, a size, a color and the like where each of objects are displayed according to a layout of a screen using a control instruction received from the detector 280. The rendering unit generates a screen with various layouts including an object based on an attribute value calculated by the calculation unit. A screen generated by the rendering unit is displayed in a display area of the display.

The main CPU 294 may access the storage 250, and perform a booting using an OS stored in the storage 250. Also, the main CPU 294 performs various operations using various kinds of programs, contents, data, and the like stored in the storage 250.

The first to nth interfaces (295-1 to 295-n) are connected with various elements described above. One of interfaces may be a network interface connected with an external apparatus through a network.

The controller 290 controls an overall operation of the user terminal device 200 according to a touch interaction of a user which is detected through the first touch detector 281 and the second touch detector 282.

<Distinction Between a Touch interaction of the Display 230 and a Touch Interaction of the Bezel Unit 235>

In response to detecting a touch interaction which touches the bezel unit 235 through the second touch detector 282, the controller 290 may perform a different function according to an area of the bezel unit 235 where the touch interaction is detected.

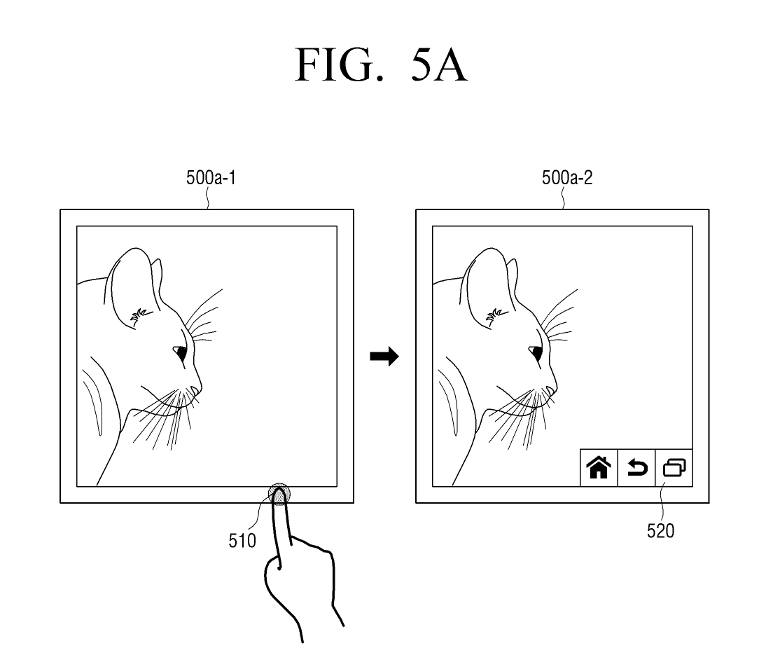

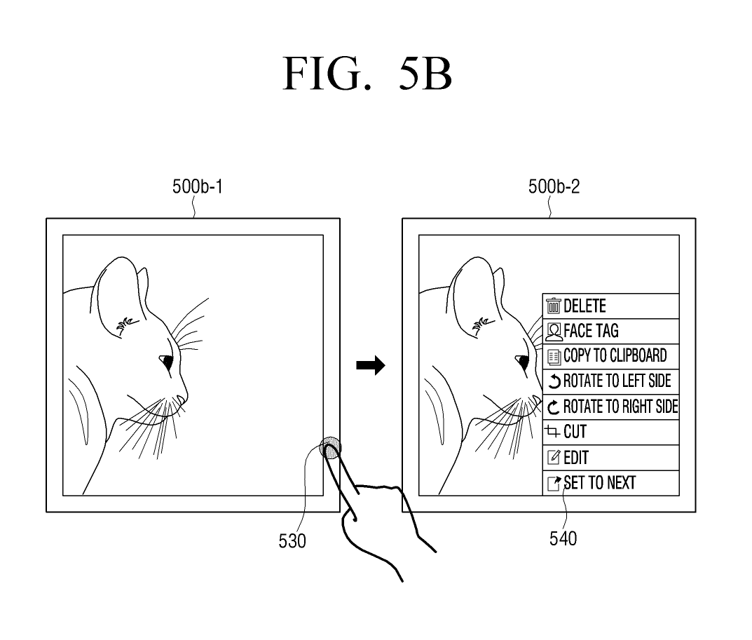

For example, as illustrated in FIG. 5A, in response to detecting a tap 510 on a bottom side of the bezel unit 235 while a gallery application displays a picture content (500a-1), the controller 290 may control the display 230 to display a home menu 520 which is in the right-bottom area of the display 230 corresponding to the tap 510 location as illustrated in 500a-2 of FIG. 5A. Herein, the user terminal device 200 is in a substantially square shape, and the bottom side of the bezel unit 235 may correspond to a bottom side of the picture content displayed on the display 230. Also, the home menu 520 displayed on a right-bottom portion of the display may include a home icon, a back icon, an icon for seeing another window, and the like.

As illustrated in FIG. 5B, in response to detecting a tap 530 on the right side of the bezel unit 235 while a gallery application displays a picture content (500b-1), the controller 290 controls the display 230 to display an edit menu 340 for editing a picture content in the right area of the display (500b-2).

That is, as illustrated in FIGS. 5A and 5B, the controller 290 may control the display 230 to display different menus according to a touched area of the bezel unit.

The controller 290 may perform different functions according to whether a tap interaction is detected on the display 230 by the first touch detector 281 or on the bezel unit 235 by the second touch detector 282.

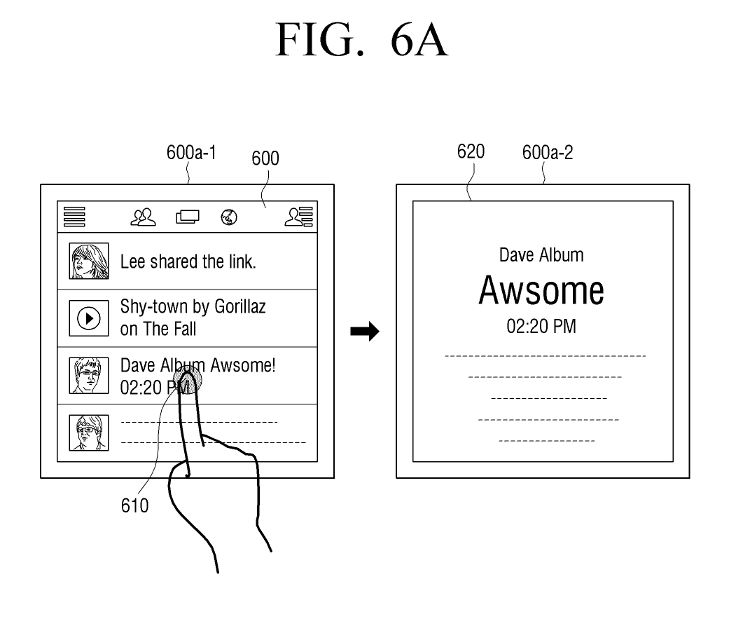

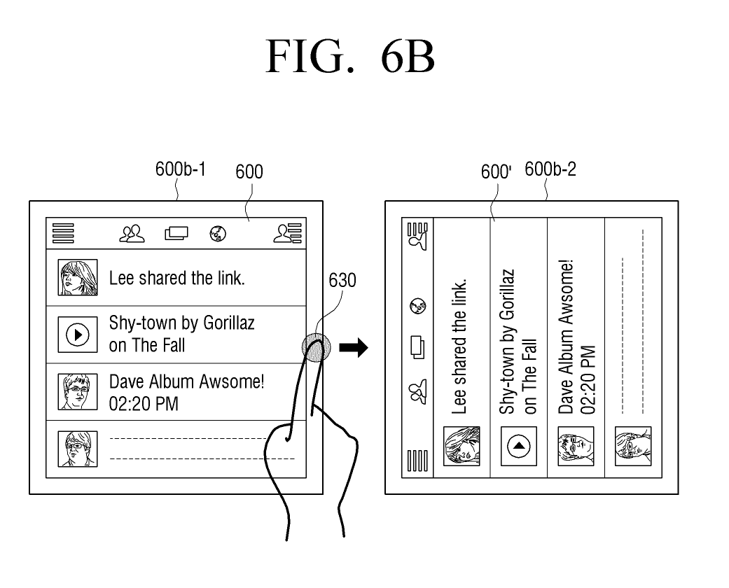

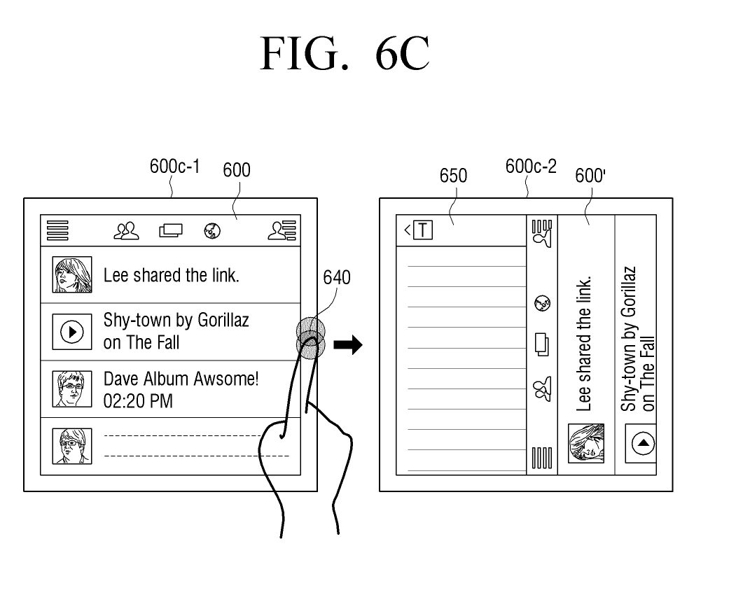

For example, as illustrated in FIG. 6A, in response to detecting a tap 610 on a the first item displayed on the display 230 while a screen 600 including a plurality of items is displayed (600a-1), the controller 290 may control the display 230 to display a display screen 620 corresponding to the first item according to the tap interaction 610 (600a-2).

As illustrated in FIG. 6B, in response to detecting a tap 630 on the right side of the bezel unit 235 while the screen 600 including a plurality of items is displayed (600b-1), the controller 290 may control the display 230 to display a screen 600′ rotated ninety degrees in a counterclockwise direction from the screen 600 (600b-2).

As illustrated in FIG. 6C, in response to detecting a double tap 640 on the right side of the bezel unit 235 while the screen 600 including a plurality of items is displayed (600c-1), the controller 290 may control the display 230 to simultaneously display an execution screen 650 of an application related to an application which is currently being executed and the screen 600′ corresponding to the screen 600 rotated ninety degrees in a counterclockwise direction according to a tap interaction 640 (600c-2).

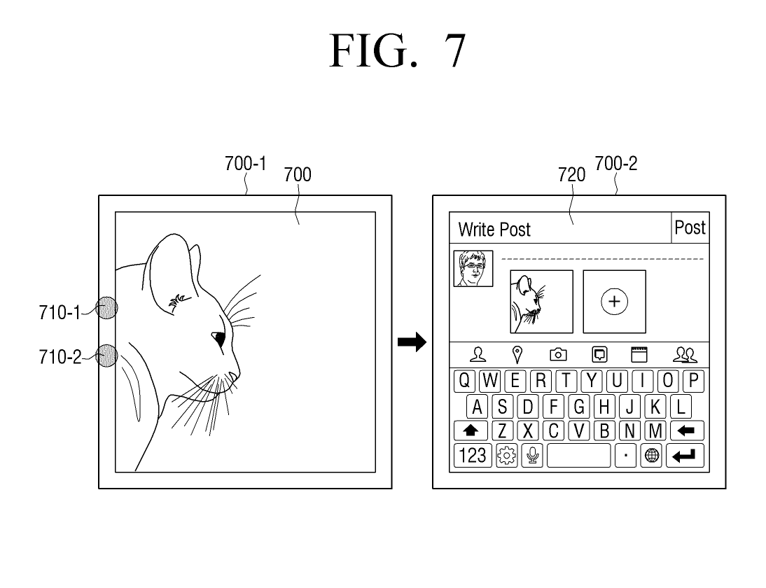

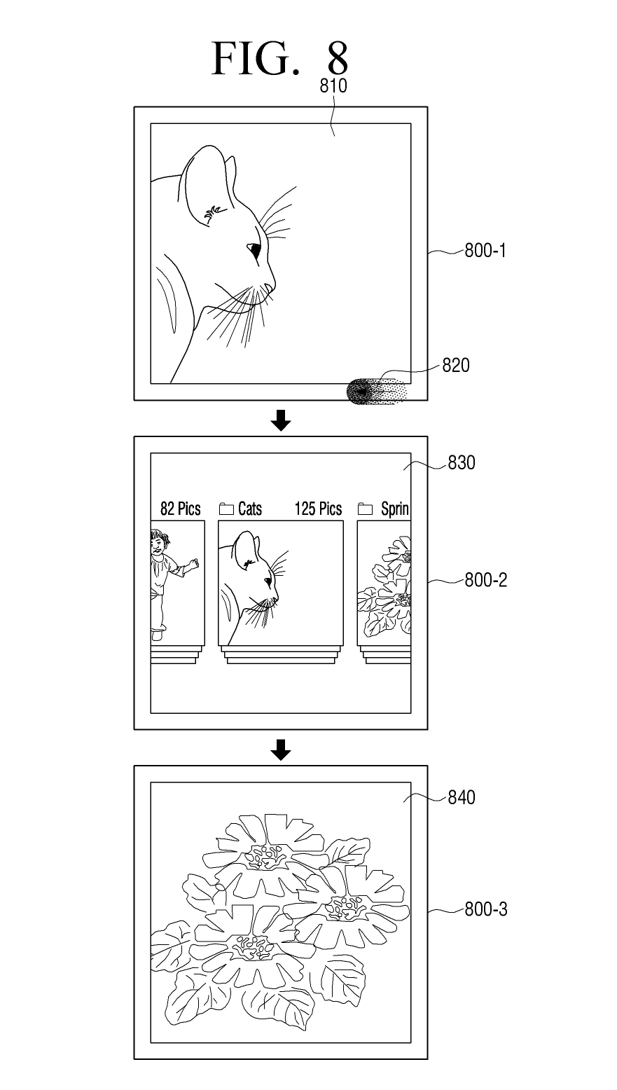

In response to detecting a user's touch on a plurality of points of the bezel unit 235 while a specific application is executed, the controller 290 may perform a quick access function, which is a frequently used function corresponding to the specific application. For example, as illustrated in FIG. 7, in response to detecting a user simultaneously tapping two points 710-1 and 710-2 on a left side of the bezel unit 235 while an execution screen 700 of a gallery application is displayed (700-1), the controller 290 may control the display 230 to display a window 720 for performing a social networking service (SNS) sharing function which is frequently used by a user when the gallery application is executed (700-2).

In response to detecting a drag interaction, i.e., a drag, on the bezel unit 235 through the second touch detector 282, the controller 290 may search a content in a higher depth level (for example, a folder unit) than a depth level where the drag interaction is detected on the display 230. The drag interaction may include touching a point on either the display 230 or the bezel unit 235 and dragging through a second point.

For example, as illustrated in FIG. 8, in response to detecting a drag 820 leftward on a bottom side of the bezel unit 235 while a first picture content 810 stored in a first folder of an gallery application is displayed (800-1), the controller 290 may control the display 230 to display a UI 830 where a thumbnail of the image content 810 in a folder unit (800-2). Also, the controller 290 may then control the display 230 to display a second picture content 840 stored in a second folder different from the first folder in response to the drag 820 (800-3).

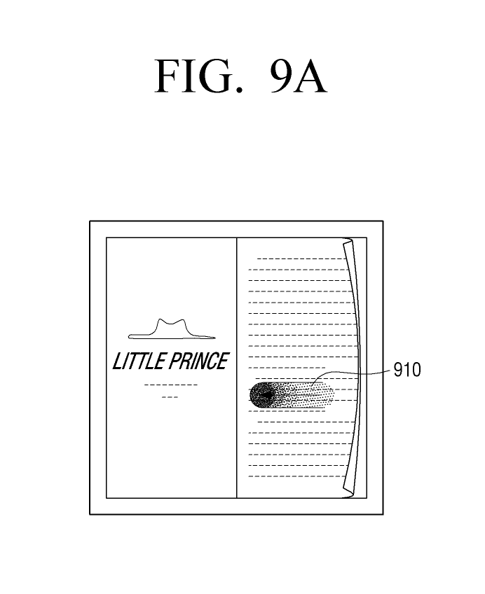

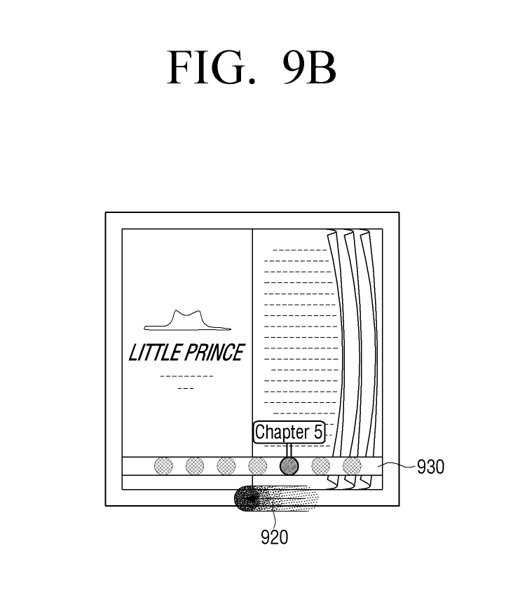

As another example, as illustrated in FIG. 9A, in response to detecting a drag 910 in a leftward direction on the display 230 through the first touch detector 281 while an e-Book application is executed, the controller 290 may control the display 230 to display the next page. That is, in response to detecting the drag 910 on the display 230, the controller 290 may convert a screen of an e-Book content in a page unit.

However, as illustrated in FIG. 9B, in response to detecting a drag 920 in a left direction on the bezel unit 235 through the second touch detector 282 while an e-Book application is executed, the controller 290 may control the display 230 to display a UI 930 which indicates a chapter of an e-Book content according to the drag interaction 910, and to display a first page of a next chapter. That is, in response to detecting a drag interaction 920 in the bezel unit 235, the controller 290 may convert a screen of the e-Book content in a chapter unit which is a higher depth than a page unit.

In response to detecting a drag interaction in the bezel unit 235 through the second touch detector 282, and in response to detecting a drag interaction in the display 230 through the first touch detector 281, the controller 290 may perform a different functions.

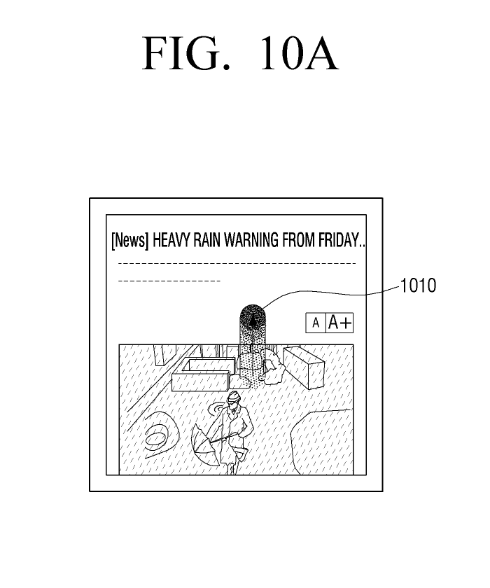

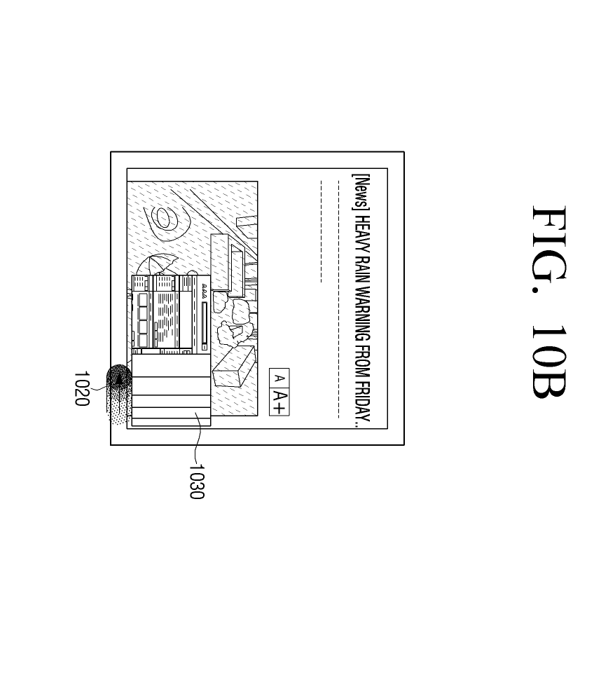

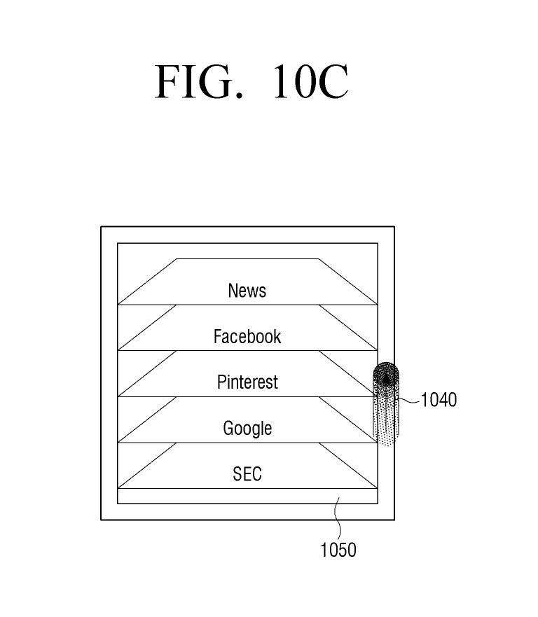

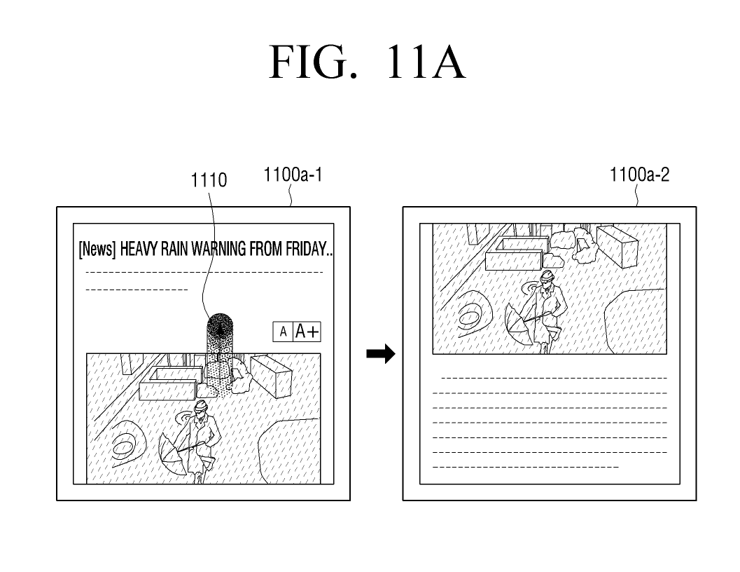

For example, as illustrated in FIG. 10A, in response to detecting a drag 1010 upwards on the display 230 through the first touch detector 281 while a news content is displayed, the controller 290 may control the display 230 to scroll the new content in the downward direction within an identical news content.

In response to detecting a drag 1020 leftward on a bottom side of the bezel unit 235 through the second touch detector 282 while a news content is displayed, the controller 290 may control the display 230 to display a history UI 1030 including a recently visited web page as illustrated in FIG. 10B. When one of a plurality of web pages included in the history UI 1030 is selected, the controller 290 may control the display 230 to display the selected web page on an entire screen.

In response to detecting a drag 1040 upwards on a right side of the bezel unit 235 through the second touch detector 282 while a news content is displayed, the controller 290 may control the display 230 to display a browsing UI 1050 where currently executing applications are able to be browsed as illustrated in FIG. 10C. Herein, when one of a plurality of applications included in the browsing UI 1050 is selected, the controller 290 may control the display 230 to display an execution screen of the selected application on an entire screen.

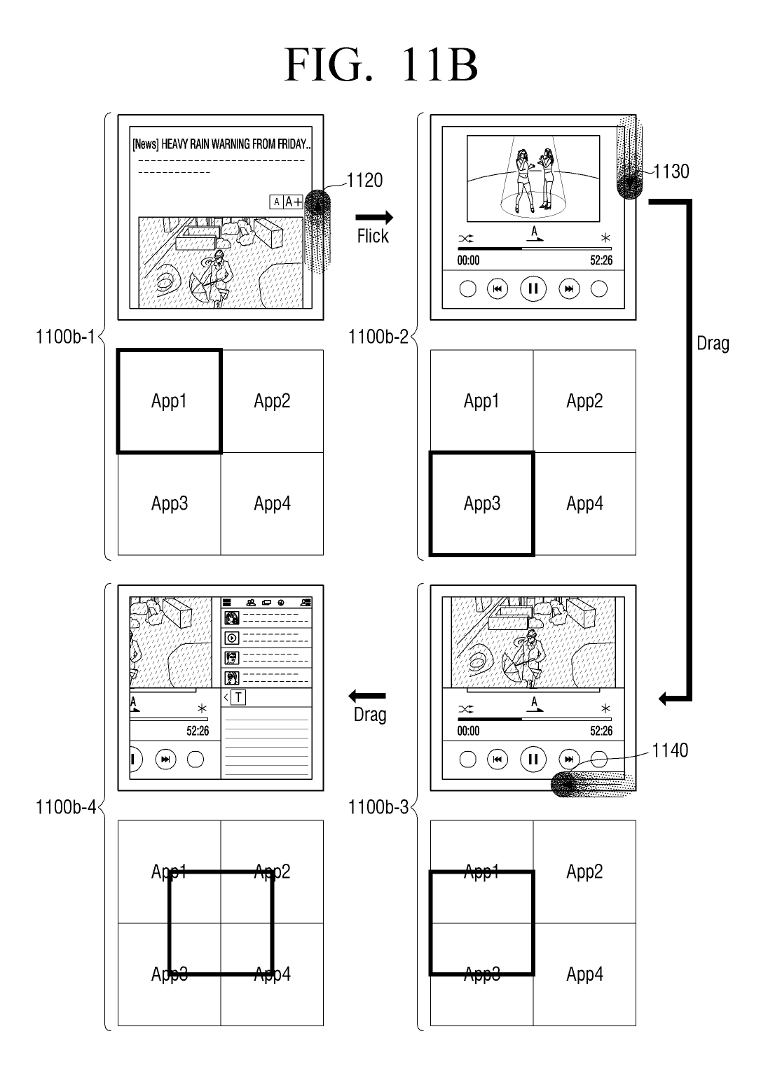

As another exemplary embodiment, as illustrated in FIG. 11A, in response to detecting a flick 1110 upwards on a the display 230 while an execution screen of a news application is displayed (1100a-1), the controller 290 may control the display 230 to scroll an execution screen of an identical news application in the downward direction (1100a-2).

However, as illustrated in FIG. 11B, in response to detecting a flick 1120 upwards on a right side of the bezel unit 235 while an execution screen of a news application is displayed as a first application (1100b-1), the controller 290 may control the display 230 to display an execution screen of a music application which is a third application (1100b-2). That is, the controller 290 may convert an execution screen between applications which are executed currently through the flick interaction 1120.

In response to detecting a drag 1130 downward on a right side of the bezel unit 235 through while an execution screen of the music application is displayed (1100b-2), the controller 290 may control the display 230 to move the execution screen of the music application in the downward direction so that the execution screen of the music application is displayed with the execution screen of the news (1100b-3). Also, in response to detecting a drag 1140 which leftward on the bottom side of the bezel unit 235 while a part of the execution screen of the news application and a part of the execution screen of the music application are displayed together, the controller 290 may control the display 230 to move a part of the execution screen of the music application and a part of the execution screen of the news application in a leftward direction so that a part of an execution screen of an SNS application which is a second application and a part of an execution screen of a memo application which is a fourth application are displayed together (1100b-4). That is, the controller 290 may move a screen according to an amount of dragging of the drags 1130 and 1140, display an execution screen regarding a plurality of applications, and perform multitasking regarding a plurality of applications.

In response to detecting a pinch interaction in the bezel unit 235 through the second touch detector 282, the controller 290 may perform a function different from a function which is performed in response to detecting a pinch interaction in the display 230 through the first touch detector 281.

Generally, in response to detecting a pinch-in interaction where two points of contact on the display 230 are brought closer together while a picture content is displayed, or in response to detecting a pinch-out interaction where two points of contact on the display 230 are brought farther apart while a picture content is displayed, the controller 290 may zoom in or zoom out the picture content according to the pinch-in interaction or the pinch-out interaction.

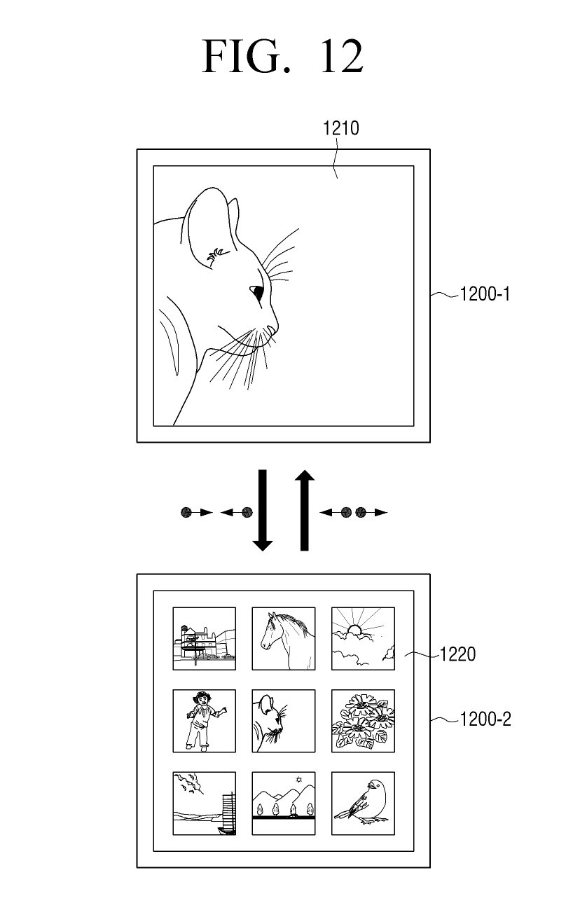

However, as illustrated in FIG. 12, in response to detecting a pinch-in interaction on the bezel unit 235 while a picture content 1210 is displayed (1200-1), the controller 290 may control the display 230 to display a folder screen 1220 including the picture content (1200-2). Also, as illustrated in FIG. 12, in response to detecting a pinch-out interaction on the bezel unit 235 through the second touch detector 282 while a folder screen is displayed (1200-2), the controller 290 may control the display 230 to display the picture content 1210 (1200-1).

The controller 290 may select or fix a partial area of the display 230 based on a touch on at least one point of the bezel unit 235.

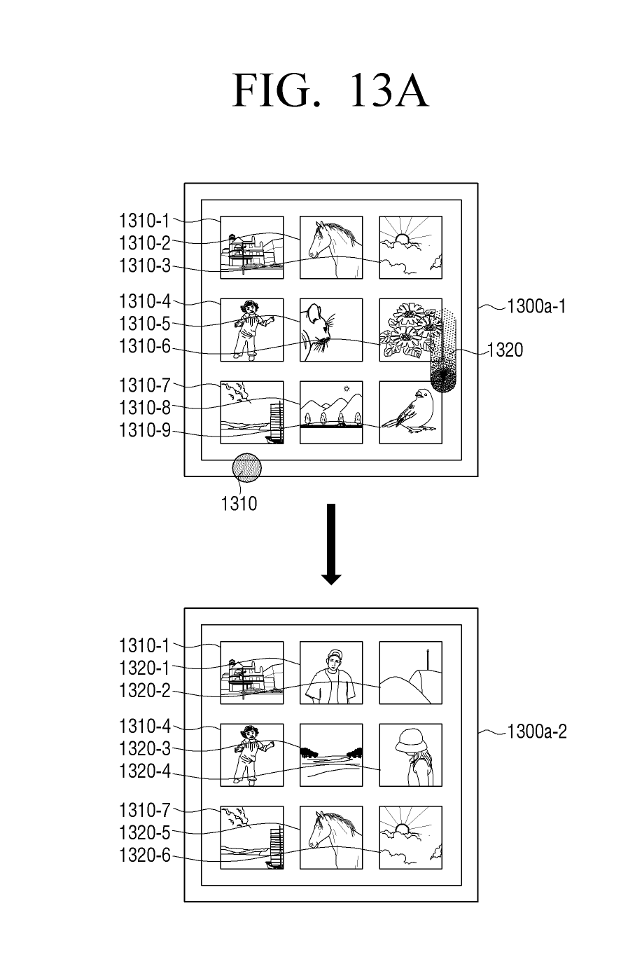

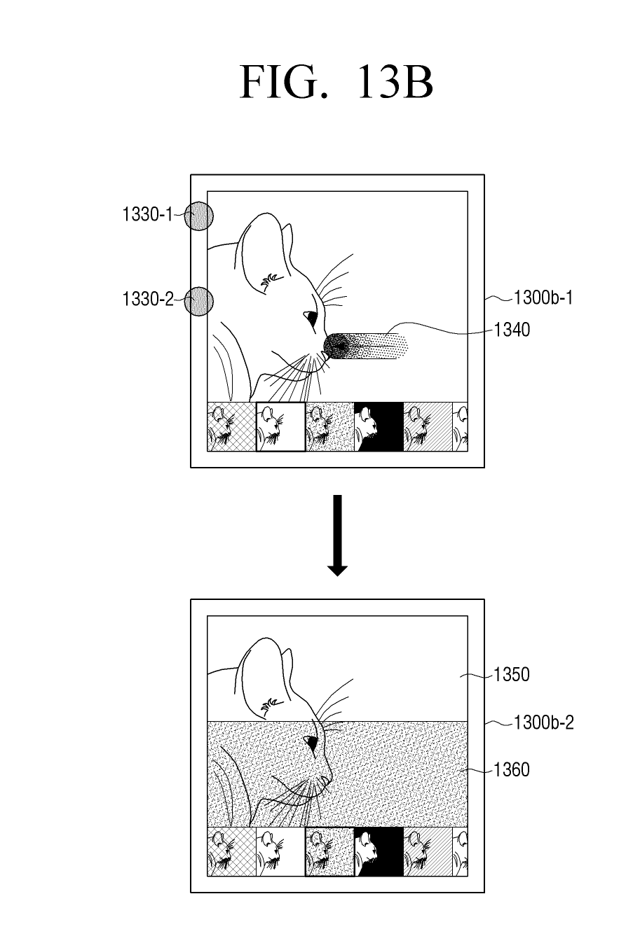

For example, as illustrated in FIG. 13A, in response to detecting a drag 1320 downward on the display 230 and a touch on a first point 1310 of the bezel unit 235 while the first to ninth thumbnail images 1310-1 to 1310-9 are displayed (1300a-1), the controller 290 may fix the first thumbnail image 1310-1, the fourth thumbnail image 1310-4 and the seventh thumbnail image 1310-7 included in the first row corresponding to the first point 1310, and change a plurality of thumbnail images 1310-2, 1310-3, 1310-5, 1310-6, 1310-8, and 1310-9 displayed in the second row and the third row to other thumbnail images 1320-1 to 1320-6 (1300a-2). That is, in response to detecting a drag after or while the first point 1310 of the bezel unit 235 corresponding to the first row is touched, the controller 290 may fix thumbnail images displayed in the first row and change thumbnail images displayed in other rows to other thumbnail images.

In response to detecting a drag 1340 in a leftward direction on the display 230 while two points 1330-1 and 1330-2 of the bezel unit 235 are touched and while an editing screen for editing the picture content is displayed as illustrated in 1300b-1 of FIG. 13B, the controller 290 may control the display 230 to maintain a previous setting value in the first area 1350 corresponding to the two points 1330-1 and 1330-2, and to process and display the second area 1360 by applying a different setting value to the second area 1360 as illustrated in 1300b-2 of FIG. 13B.

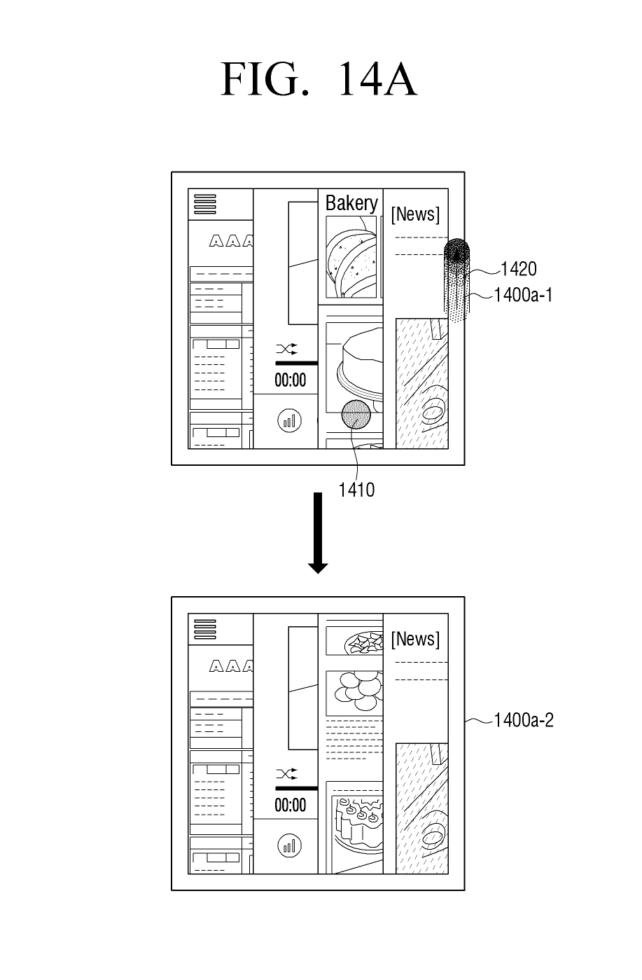

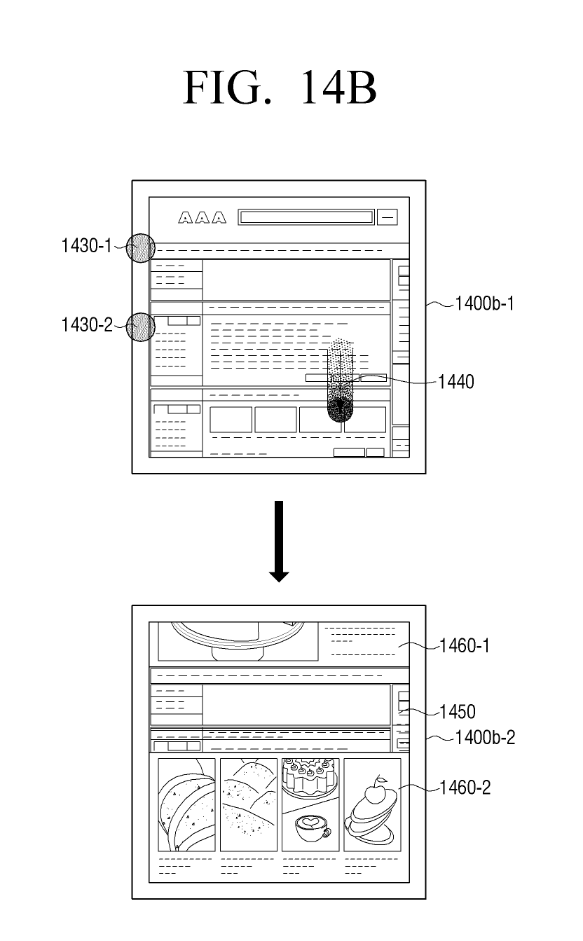

As illustrated in FIG. 14A, in response to detecting a drag 1420 upwards on a right side of the bezel unit 235 while first to fourth applications are displayed simultaneously (1400a-1), the controller 290 may control the display 230 to scroll the third application to the upper direction while keeping the first application, the second application, and the fourth application stationary (1400a-2).

In response to detecting a drag interaction 1440 downward on the display while two points 1430-1 and 1430-2 of the bezel unit 235 are touched and while a web page is displayed as illustrated in 1400b-1 of FIG. 14B, the controller 290 may control the display 230 to maintain a first portion 1450 of the web page corresponding to the two points 1430-1 and 1430-2, and scroll the second areas 1460-1 and 1460-2 (1400b-2).

<A Multi Touch Interaction Inputted to a Plurality of Sides of the Bezel Unit 235>

When two points of the bezel unit 290 are touched, the controller 290 may control the display 230 to divide a display screen into a plurality of areas based on two touched points, and to display a different images on the plurality of areas.

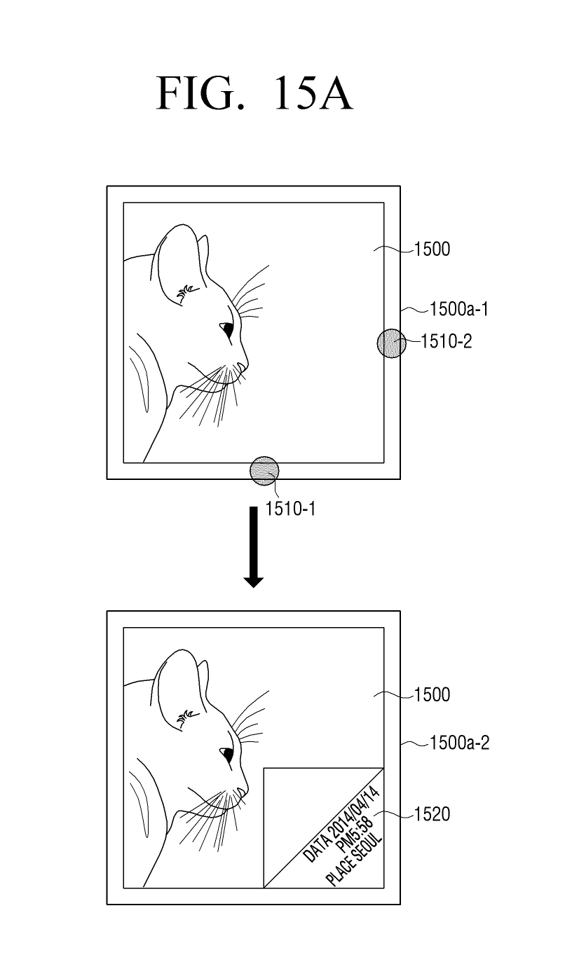

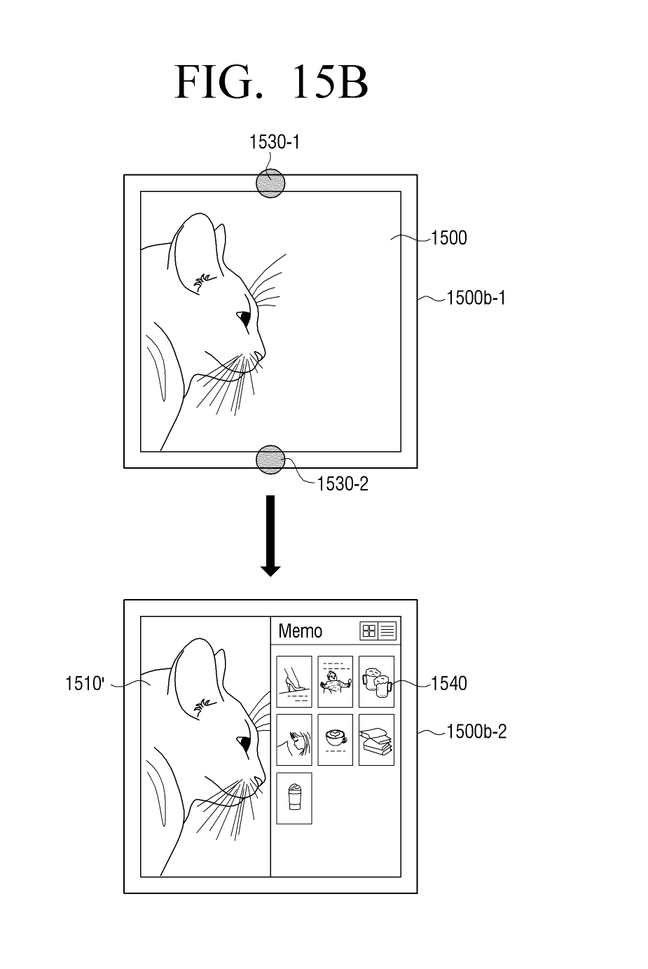

For example, as illustrated in FIG. 15A, in response to detecting a touch on a first point 1510-1 on a bottom side and a touch on a second point 1510-2 on a right side of the bezel unit 235 for a predetermined time while a picture content 1500 is displayed (1500a-1), the controller 290 may control the display 230 to display a UI 1520 which introduces detail information of the picture content 1500 on a corner area corresponding to the first point 1510-1 and the second point 1510-2 (1500a-2). Herein, as illustrated in FIG. 15A, the controller 290 may control the display to display a UI 1520 where the picture content 1500 is folded corresponding to the first point 1510-1 and the second point 1510-2 and detail information of the picture content 1500 is displayed (1500a-2).

As illustrated in FIG. 15B, in response to detecting a touch on a first point 1530-1 on an upper side and a touch on a second point 1530-2 of a bottom side of the bezel unit 235 for a predetermined time while the picture content 1500 is displayed (1500b-1), the controller 290 may control the display 230 to divide the display screen into two areas based on the first point 1530-1 and the second point 1530-2, to display a part 1510′ of the picture content 1500 on a first area, and to display an execution screen of a memo application related to the picture content 1500 on a second area (1500b-2). That is, the controller 290 may enter into a multitasking mode through a touch on a plurality of points of the bezel unit 235.

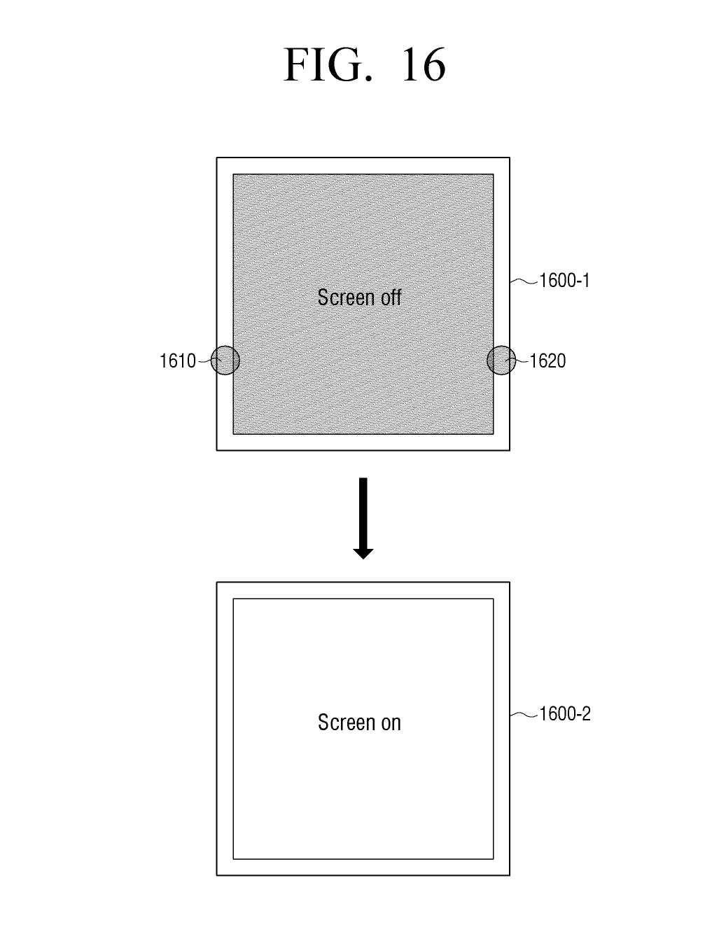

As illustrated in FIG. 16, in response to detecting a touch interactions on two points 1610 and 1620 of the bezel unit 235 through the second touch detector 282 for a predetermined time while a display screen is turned off (1600-1), the controller 290 may control the display 230 to turn on the display screen as illustrated in 1600-2. That is, a power control of the display may be performed through a multi-touch of the bezel unit 235.

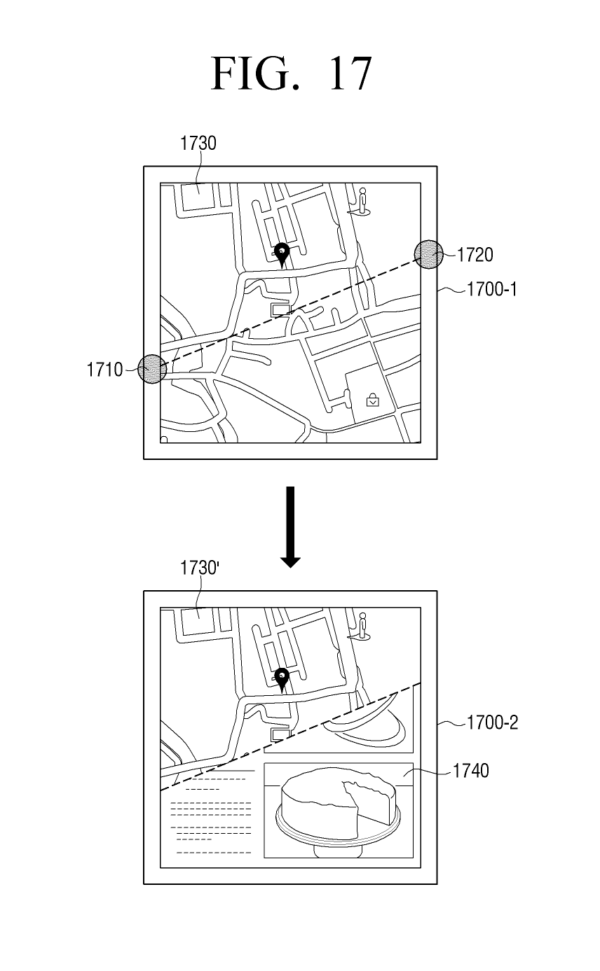

As illustrated in FIG. 17, in response to detecting a touch on a the first point 1710 on a left side of the bezel unit 235 and a touch on a second point 1720 on a right side of the bezel unit 235 while a map application 1730 is displayed (1700-1), the controller 290 may control the display 230 to divide a display screen into first and second areas based on the first point 1710 and the second point 1720, and to display a part 1730′ of the map application on the first area, and to display a web page 1740 on the second area. A line connecting the first and second points 1710 and 1720 may server as a dividing line between the first and second areas. Herein, a web page 1740 may be an application which is executed before the map application 1730 is executed. That is, the controller 290 may divide a screen in response to a touch interaction on a plurality of points of the bezel unit 235.

Also, the controller 290 may enlarge or reduce a screen displayed currently through a drag interaction on a plurality of sides of the bezel unit 235.

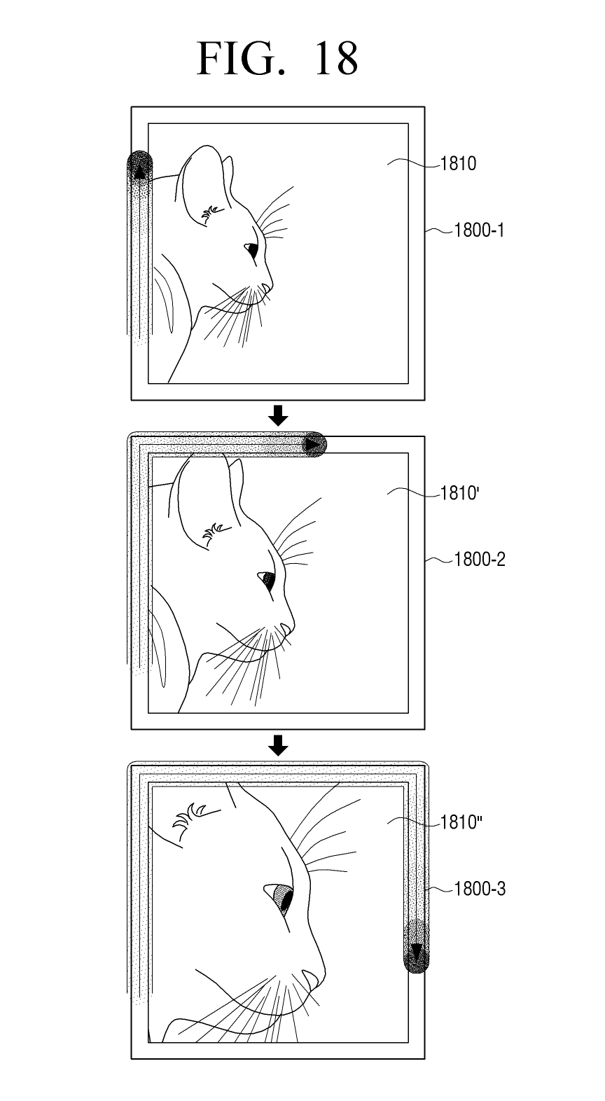

For example, in response to detecting a drag interaction on a left side of the bezel unit 235 in a clockwise direction while a picture content 1810 is displayed as illustrated in 1800-1 of FIG. 18, the controller 290 may control the display 230 to enlarge the picture content 1810 and display the enlarged picture contents 1810′ and 1810″ as illustrated in the 1800-2 and 1800-3 of FIG. 18.

In response to detecting a drag interaction of the bezel unit 235 in a counterclockwise direction while the picture content 1810 is displayed, the controller 290 may control the display 290 to shrink the picture content 1810 and display the shrunken picture content.

Also, the controller 290 may control a number of images displayed on the display 230 through a drag interaction on a plurality of sides of the bezel unit 235.

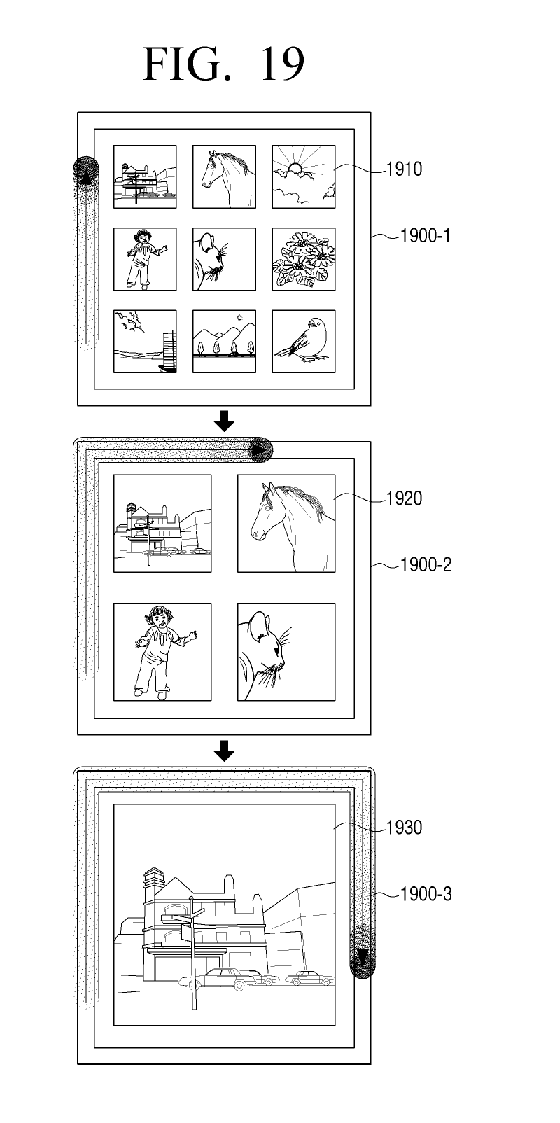

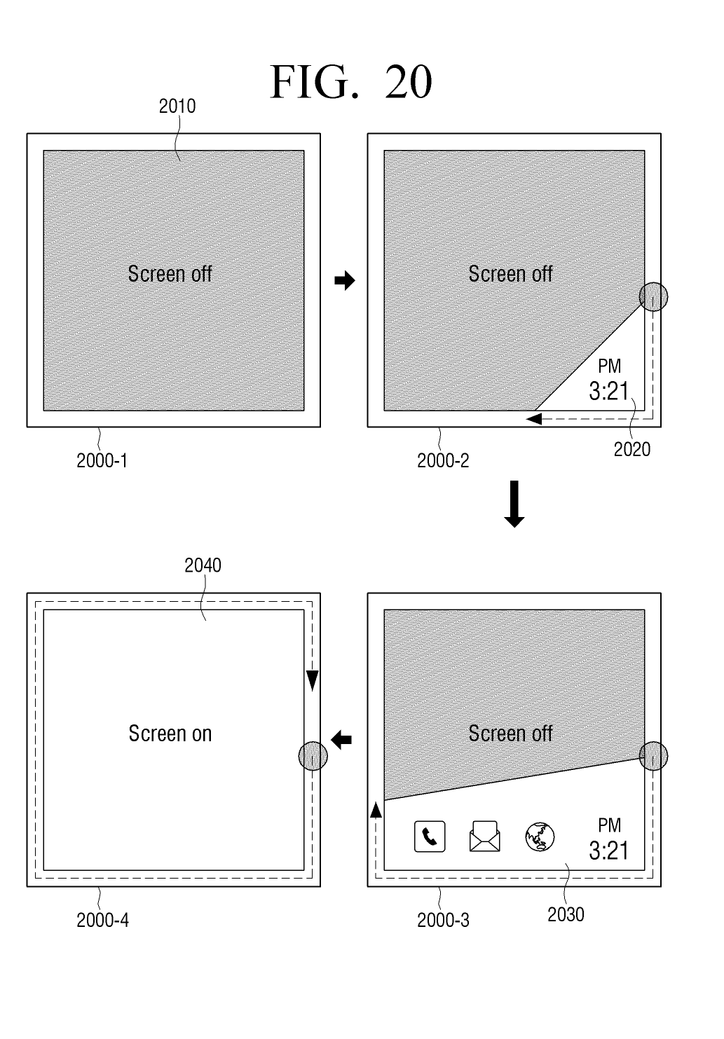

For example, as illustrated in the top of FIG. 19, in response to detecting a drag interaction upwards on a left side of the bezel unit 235 while a screen 1910 including 9 images is displayed (1900-1), the controller 290 may control the display 230 to display a screen 1920 including 4 images among the 9 images as illustrated in 1900-2 of FIG. 19. When the drag interaction is continued towards a right side of the bezel unit 235 along the upper side of the bezel unit (1900-2), the controller 290 may control the display 230 to display a screen 1930 including only one image from among the 4 images as illustrated in 1900-3. Conversely, the controller 290 may increase the number of images displayed on the display 230 according to a drag interaction on the bezel unit 235 in the counterclockwise direction.

Also, the controller 290 may turn on the display 230 according to a drag interaction on at least two sides of the bezel unit 235.

For example, as illustrated in FIG. 20, in response to detecting a drag interaction downward from a right side of the bezel unit 235 in the clockwise direction while the display 230 is turned off 2010 (2000-1), the controller 290 may control the display 230 to display time information on a first area 2020 of a display screen corresponding to the drag interaction as illustrated in 2000-2 of FIG. 20. When a drag interaction is continued to a left side of the bezel unit, the controller 290 may control the display 230 to display time information and shortcut icons of applications which are frequently used on a second area 2030 of the display screen 2000-3. When the drag interaction is continued back to a right side of the bezel unit 235, the controller 290 may control the display 230 to turn on an entire screen as illustrated in 2000-4 of FIG. 20. That is, the controller 290 may turn on the display 230 through a drag interaction which is inputted into at least two sides of the bezel unit 235.

The controller 290 may search a plurality of images through a drag interaction which simultaneously touches a point of each of two sides of the bezel unit 235.

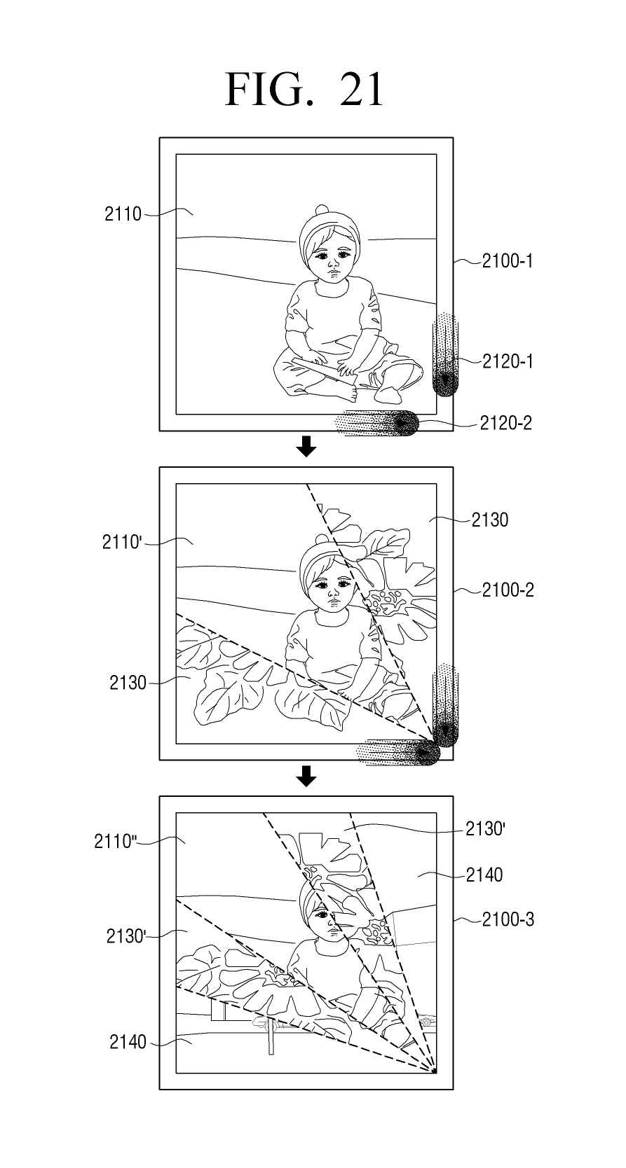

For example, as illustrated in the top of FIG. 21, in response to detecting drag interaction 2120-1 downward on a right side of the bezel unit 235 and drag interaction 2120-2 rightward on a bottom side of the bezel unit 235 (2100-2), the controller 290 may control the display 230 to display the second image 2130 besides the first image 2110′ as illustrated in 2100-2 of FIG. 21. In response to detecting the drag interactions 2120-1 and 2120-2 continuing to move in downward and rightward, respectively (2100-2), the controller 290 may control the display 230 to simultaneously display the first image 2110″, the second image 2130′ and the third image 2140 as illustrated in 2100-3 of FIG. 21. Herein, the first image 2110, the second image 2130 and the third image 2140 may be pictures with a similar color, or pictures taken on a same date.

The controller 290 may rotate a screen based on drag interactions in opposite directions (i.e., one dragging leftward and the other rightward, or one dragging upward and the other downward) on opposite sides of the bezel unit 235.

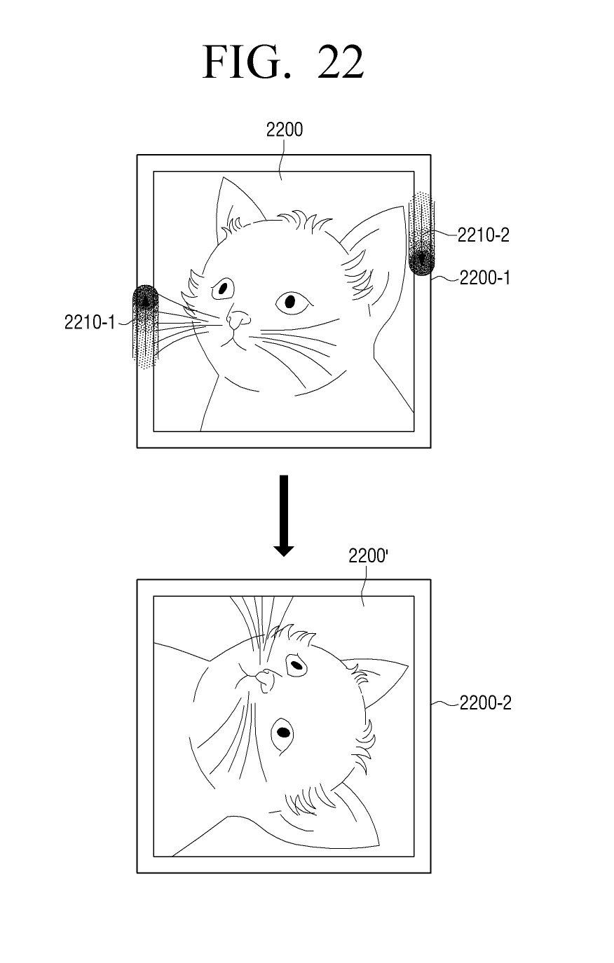

For example, as illustrated in FIG. 22, in response to simultaneously detecting a first drag 2210-1 upward on a left side of the bezel unit 235 and a second drag 2210-2 downward on a right side of the bezel unit 235 (2200-2), the controller 290 may control the display 230 to display a picture content 2200′ which is rotated 90 degrees in the clockwise direction (2200-2).

The controller 290 may perform various functions of the user terminal device through a swipe interaction which simultaneously swipes a first side of the bezel unit 235 and a second side of the bezel unit 235 which adjoins the first side.

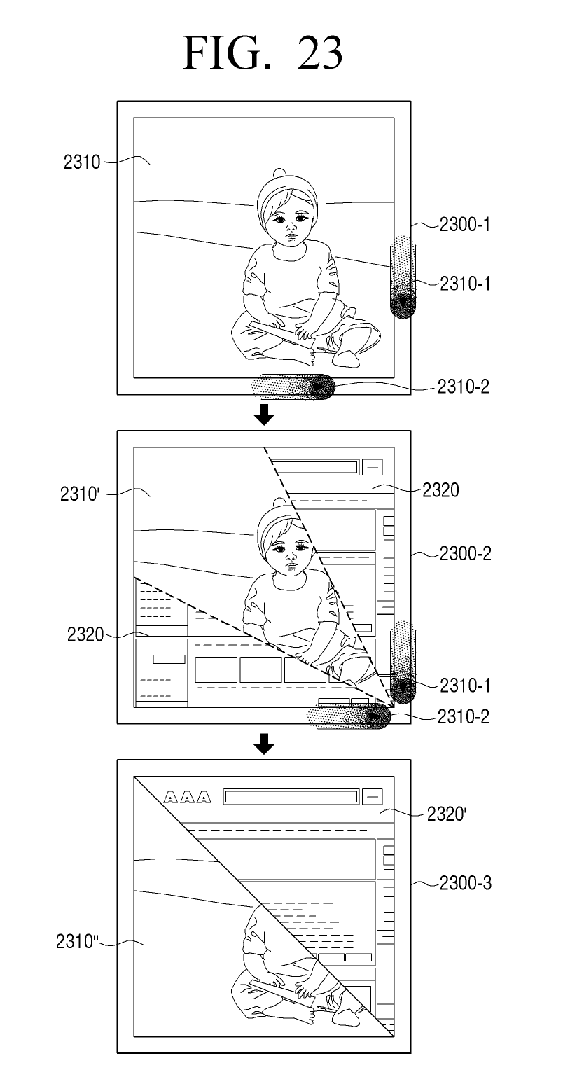

For example, as illustrated in FIG. 23, in response to detecting a swipe interaction 2310-1 downward on the left side of the bezel unit 235 and a swipe interaction 2310-2 rightward on a bottom side of the bezel unit 235 while a gallery application 2310 is displayed (2300-1), the controller 290 may control the display 230 to display an internet application 2320 beside a gallery application 2310′ as illustrated in 2300-2 of FIG. 23. In response to detecting the swipe interactions 2310-1 and 2310-2 continuing in respective downward and rightward directions (2300-2), the controller 290 may control the display 230 to divide a display screen and simultaneously display the gallery application 2130′ and the internet application 2320′ as illustrated in 2300-3 FIG. 23. Accordingly, the controller 290 may enter into a multitasking mode where a plurality of applications are simultaneously displayed.

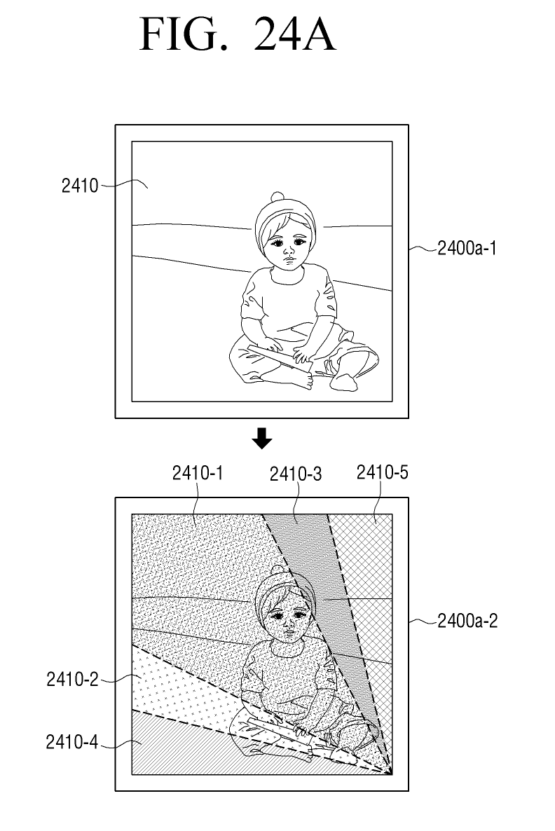

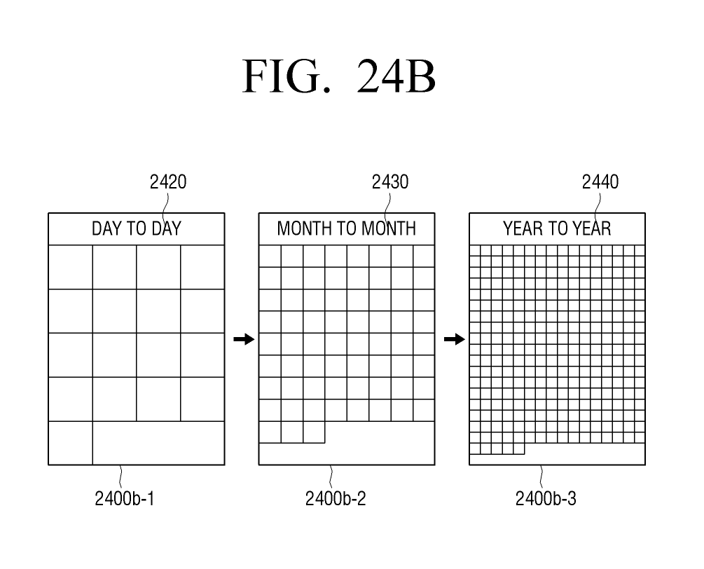

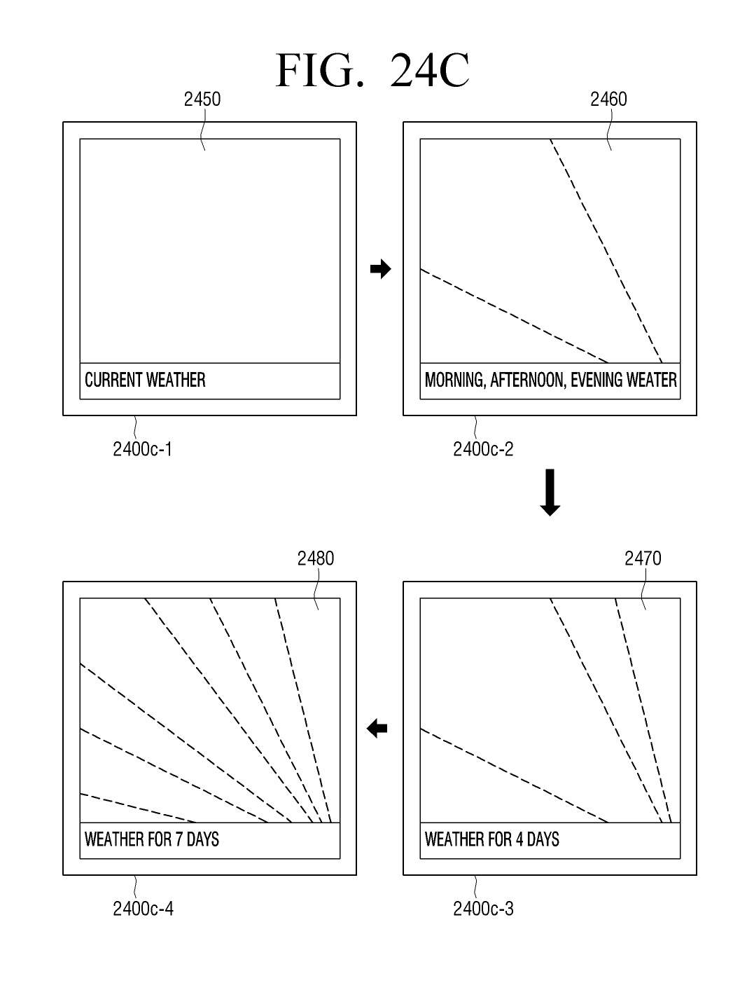

As illustrated in the top of FIG. 24A, in response to detecting a swipe downward on a right side and a swipe rightward on a bottom side of the bezel unit 235 while a picture content 2410 is displayed (2400-1), the controller 290 may control the display 230 to divide the picture content 2410 into a plurality of areas 2410-1 to 2410-5, to apply different image values to the plurality of areas 2410-1 to 2410-5, and to display the plurality of areas 2410-1 to 2410-5 as illustrated in 2400a-2 of FIG. 24A.

As illustrated in FIG. 24B, in response to detecting a swipe downward on the right side and a swipe rightward on a bottom side of the bezel unit 235 while a UI 2420 where a picture content is arranged by day (2400b-1), the controller 290 may control the display 230 to display a UI 2430 where a picture content is arranged by month (2400b-2). In response to detecting a swipe downward on the right side and swipe rightward on the bottom side of the bezel unit 235 while the UI 2430 where a picture content is arranged by month is displayed (2400b-2), the controller 290 may control the display 230 to display a UI 2440 where a picture content is arranged by year as illustrated in 2400b-3 of FIG. 24C.

As illustrated in FIG. 24C, in response to detecting a swipe downward on a right side and a swipe rightward on a bottom side of the bezel unit 235 when a screen 2450 of a weather application describing a current weather is displayed (2400c-1), the controller 290 may control the display 230 to divide a display screen into three areas and to display a screen 2460 which describes the weather during morning, afternoon, and evening as illustrated in 2400c-2 of FIG. 24C. Further, in response to detecting a swipe downward on the right side and a swipe rightward on the bottom side of the bezel unit 235 while a screen 2460 which describes the weather of morning, afternoon and evening is displayed (2400c-2), the controller 290 may control the display 230 to divide the display screen into 4 areas, and to display a screen 2470 which describes the weather over 4 days as illustrated in 2400c-3 of FIG. 24C. In response to detecting a swipe downward on the right side and a swipe rightward on the bottom side of the bezel unit 235 while the screen 2470 is displayed (2400c-3), the controller 290 may control the display 230 to divide the display screen into seven areas and to display a screen 2470 which describes the weather over a week as illustrated in 2400c-4 of FIG. 24C.

Functions performed in response to detecting a swipe downward on a right side and a swipe rightward on the bottom side of the bezel unit 235 are explained above, but these are merely examples, and the user terminal 200 may perform various functions in response to detecting various inputs. For example, in response to detecting a swipe upward on the right side and a swipe leftward on the bottom side of the bezel unit 235, an function may be performed that is an opposite of the function performed in response to detecting a swipe interaction downward on the right side and a swipe rightward on the bottom side of the bezel unit 235.

In response to detecting a swipe upward on the right side and a swipe leftward on the bottom side of the bezel unit 235, the controller 290 may control the display 230 to display notification information (for example, received message information, missed call information, update information and the like) on a bottom-right corner area of the display.

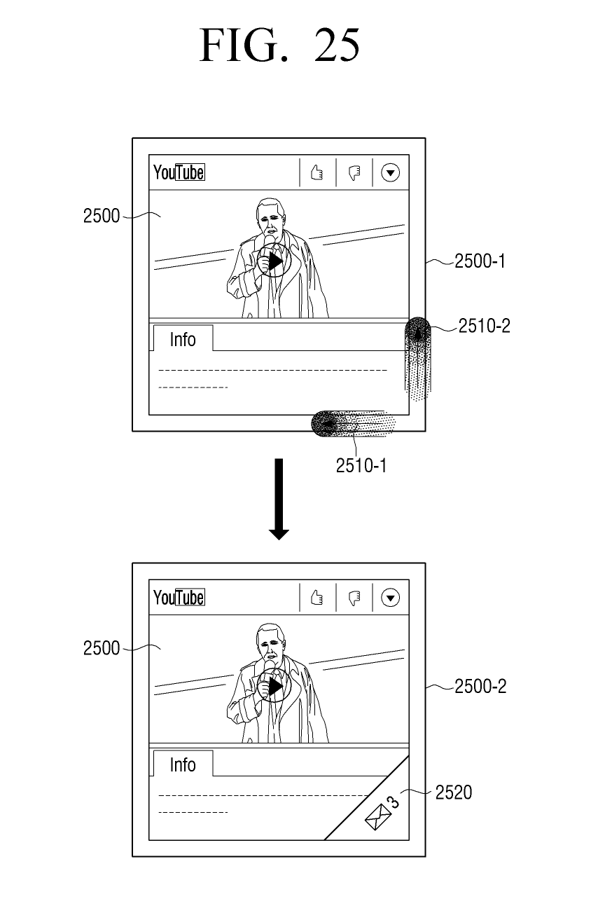

For example, as illustrated in FIG. 25, in response to detecting a swipe 2510-1 upward on a right side and a swipe 2510-2 leftward on a bottom side of the bezel unit 235 while an image application 2500 is displayed (2500-1), the controller 290 may control the display 230 to display text message notification information on a bottom-right corner area 2520 corresponding to where the swipe interactions 2510-1 and 2510-2 are detected. A size of the bottom-right corner area 2520 where the text message notification information is displayed may change according to an amount of swiping.

The controller 290 may perform a function of scrolling at different speeds according to various drag interactions inputted to the bezel unit 235.

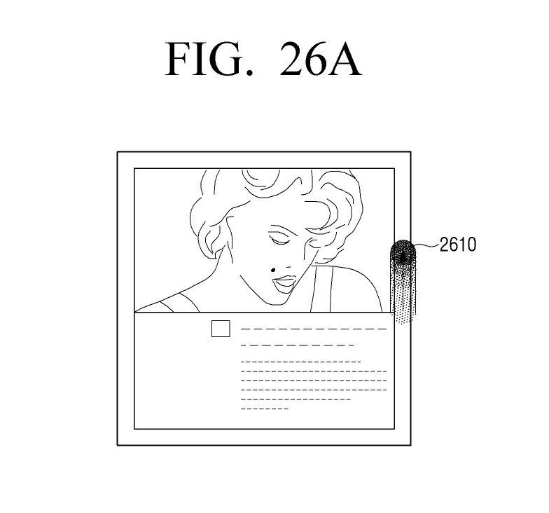

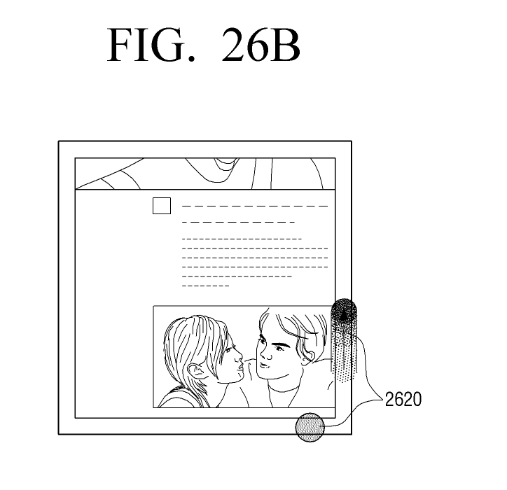

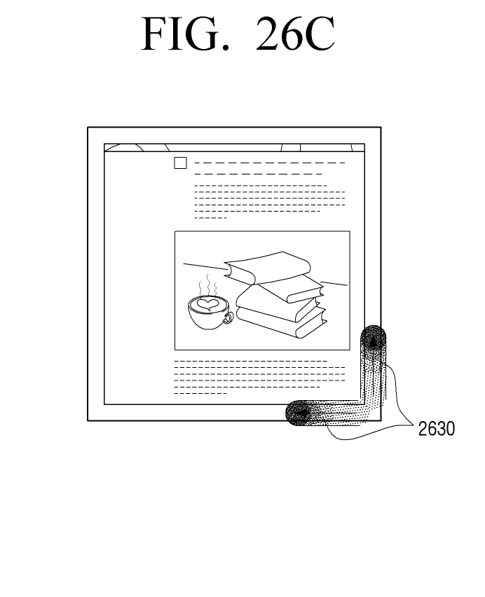

As illustrated in FIG. 26A, in response to detecting an upward drag interaction 2610 on the right side of the bezel unit 235 while a web page is displayed, the controller 290 may control a display 230 to scroll the web page at a first speed.

As illustrated in FIG. 26B, in response to detecting an upward drag interaction 2620 on the right side of the bezel unit 235 and a touch 2620 on a bottom side of the bezel unit 235 while a web page is displayed, the controller 290 may control the display 230 to scroll the web page at a second speed which is twice as fast as the first speed.

As illustrated in FIG. 26C, in response to detecting a drag interaction 2630 upward on a right side and a drag interaction 2630 on a bottom side of the bezel unit 235 while a web page is displayed the controller 290 may control the display 230 to scroll the web page at a third speed which is four times faster than the first speed.

Further, the controller 290 may provide a multitasking function according to swipe interactions on adjoining of the bezel unit 235.

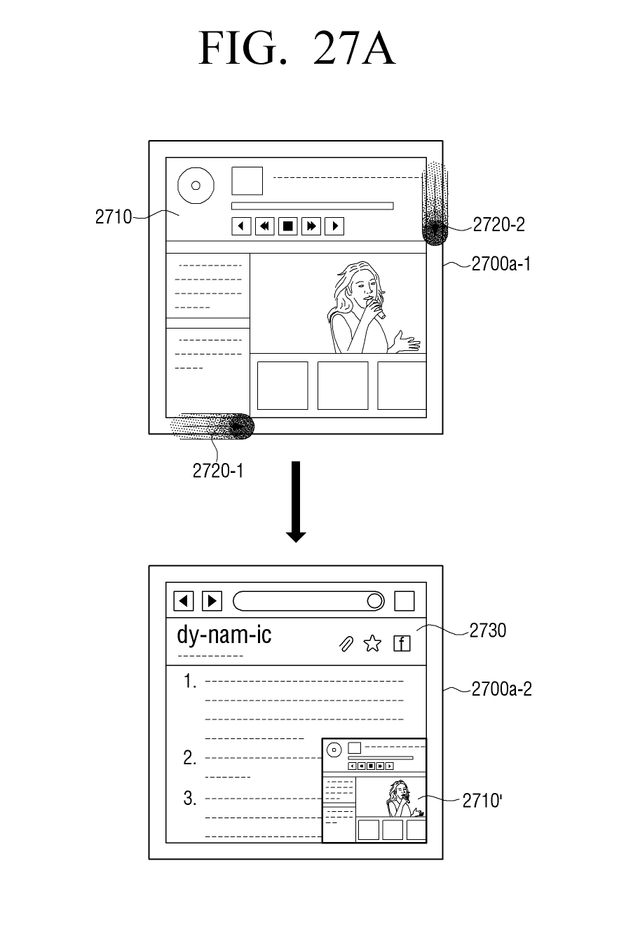

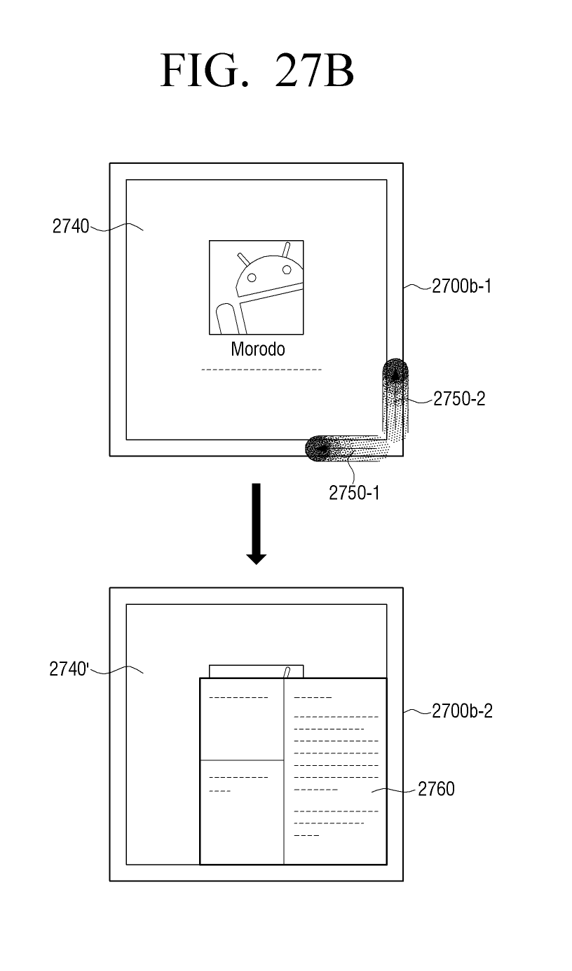

For example, as illustrated in FIG. 27A, in response to detecting a swipe 2720-1 rightward on a bottom side and a swipe 2720-2 downward on a right side of the bezel unit 235 while the first application 2710 is displayed (2700a-1), the controller may reduce a size of the first application 2710′ and to display a second application 2730 as illustrated in 2700a-2 of FIG. 27A. The size of the first application 2710′ may be reduced corresponding to the swipes 2720-1 and 2720-2.

As illustrated in FIG. 27B, in response to detecting a swipe 2750-1 leftward on a bottom side and a swipe 2750-2 upward on a right side of the bezel unit through the second touch detector 282 while the third application 2740 is displayed (2700b-1), the controller 290 may control the display 230 to enlarge and display a fourth application 2760 over the third application 2740′ as illustrated in 2700b-2 of FIG. 27B.

The controller 290 may provide a multitasking function based on drag interactions on opposite sides of the bezel in a same direction.

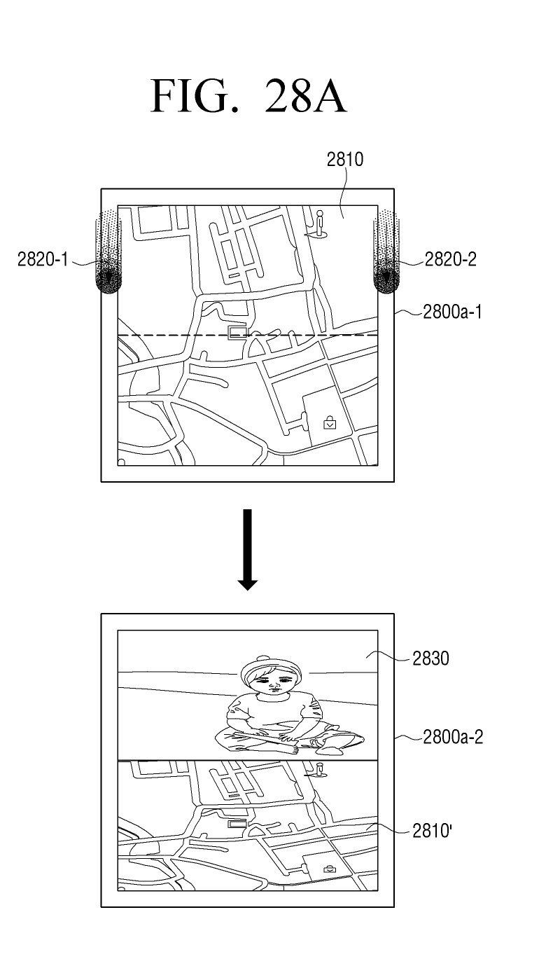

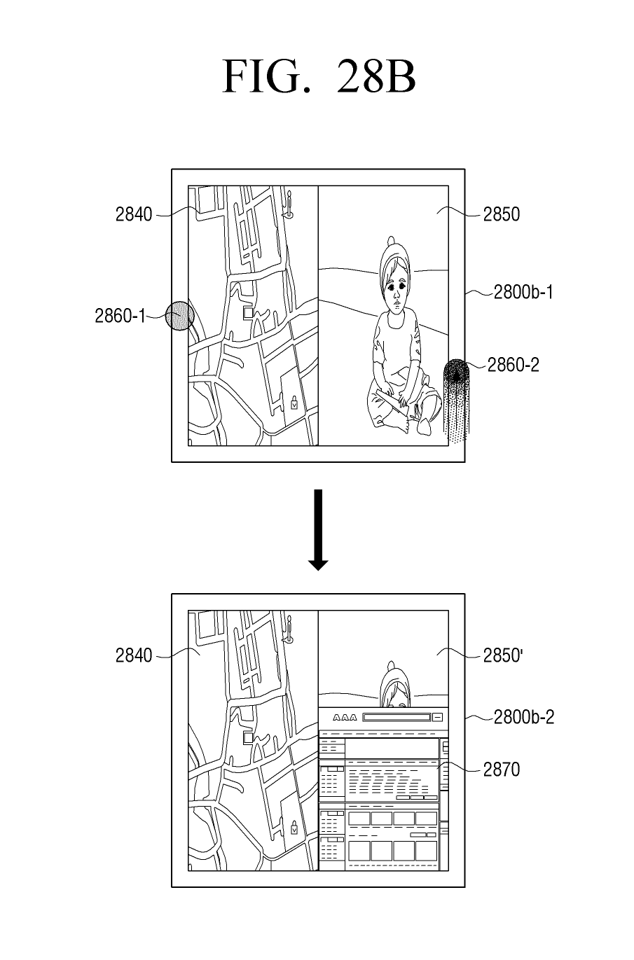

For example, as illustrated in FIG. 28A, in response to detecting a drag interaction 2820-1 downward on a left side and a drag interaction 2820-2 downward on a right side of the bezel unit 235 while a map application 2810 is displayed (2800a-1), the controller 290 may control the display 230 so that a gallery application 2830 moves downward from the top of a display screen, and to display the map application 2810′ and the gallery application 2830 simultaneously (2800a-2).

As illustrated in FIG. 28B, while a display screen is divided into left and right areas so that a map application 2840 is displayed on the left area and a gallery application 2850 is displayed on the right area, in response to detecting a drag 2860-2 upward on a right side and a touch 2860-1 on a left side of the bezel unit 235 (2800b-1), the controller 290 may control the display 230 so that an internet application 2870 rises from the bottom of the display screen corresponding to the drag interaction 2860-2, and may control the display 230 to simultaneously display a gallery application 2850′ and an internet application 2870 on the right area as illustrated in 2800b-2 of FIG. 28B.

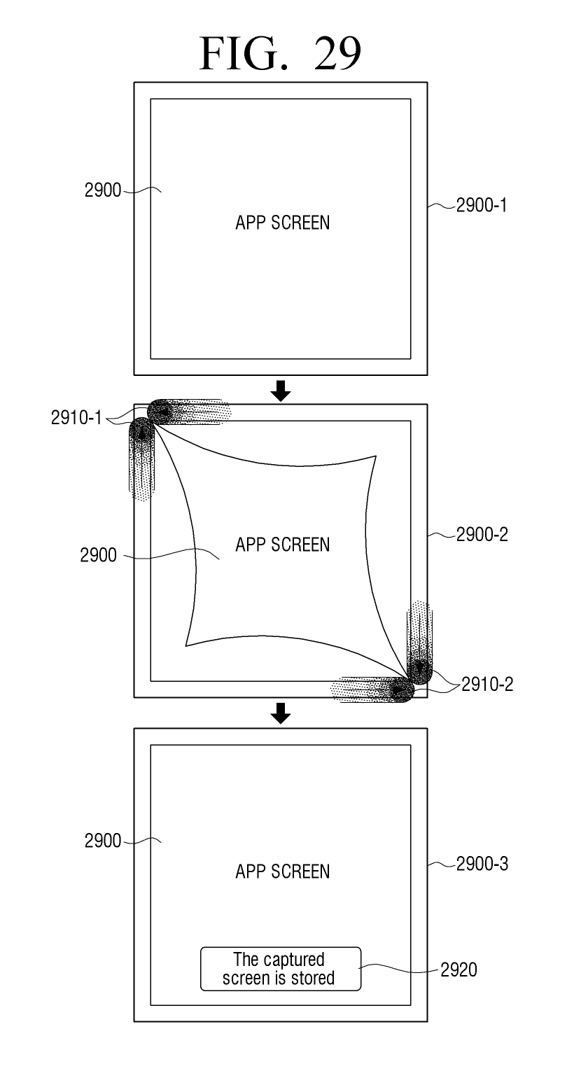

As illustrated in FIG. 29, in response to simultaneously detecting a first drag interaction 2910-1 leftward on the upper side and upward on the left side of the bezel unit 235 and a second drag interaction 2910-2 rightward on a bottom side and downward on a right side of the bezel unit 235 (2900-1), the controller 290 may provide an image effect where the application screen 2900 is pinched corresponding to the first drag interaction 2910-1 and the second drag interaction 2910-2 as illustrated in 2900-2 of FIG. 29, and may capture a screen shot of the application 2900 and removes the image effect as illustrated in 2900-3 of FIG. 29. The controller 290 may control the display 230 to display a UI 2920 which describes that an application screen 2900 is stored.

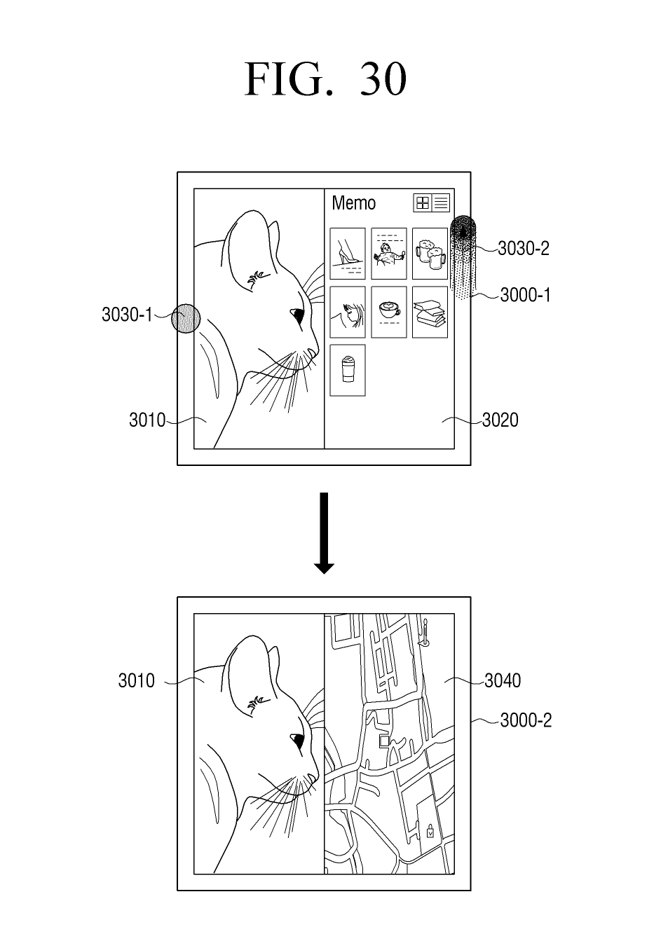

As illustrated in FIG. 30, while a display screen is divided into left and right areas so that a gallery application 3010 is displayed on the left area of the display screen and a memo application 3020 is displayed on the right area of the display screen, in response to detecting a drag interaction 3030-2 upward on a right side of the bezel unit 235 and a touch 3030-1 on a left side of the bezel unit 235 (3000-1), the controller 290 may control the display 230 to fix the gallery application displayed on the left area and to display the map application 3040 on the right area (3000-2). The map application 3040 may be representative of an application which was executed most recently executed before the gallery application 3010 and the memo application 3020 were executed. Accordingly, the controller 290 may convert an application displayed on a part of the display 230 to another application through a touch interaction 3030-1 and a drag interaction 3030-2.

<Other Bezel Interactions>

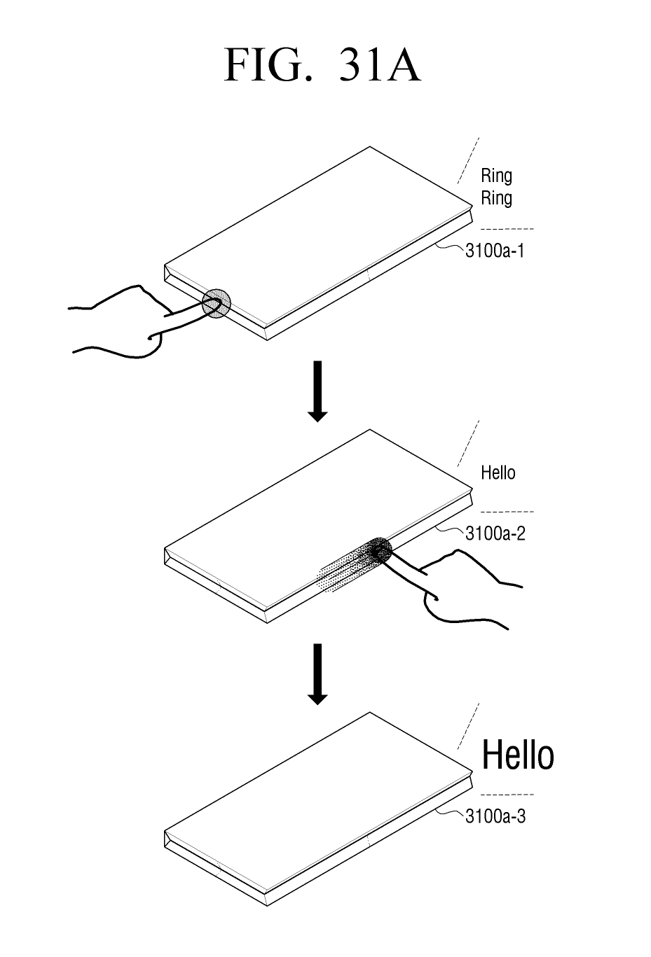

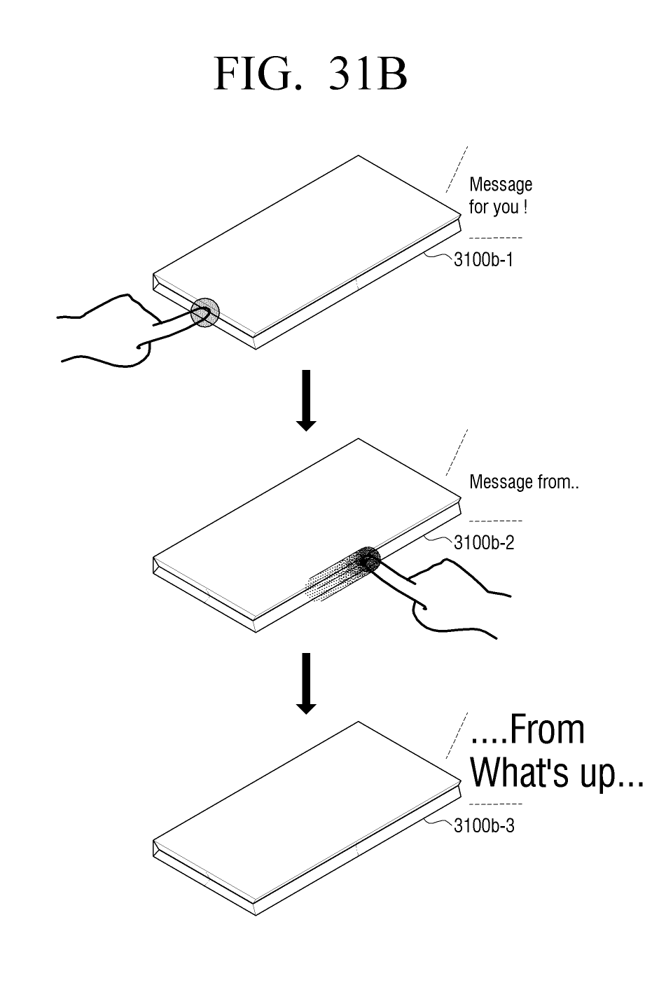

In response to receiving a telephone call while the user terminal device 200 is folded, the controller 290 may control a speaker 270 to output a call reception sound (3100a-1). Herein, as illustrated in FIG. 31A, in response to detecting a tap on the bezel unit 235 (3100a-1), the controller 290 may control terminal device 200 to establish a telephone connection and control the speaker 270 output a telephone communication sound (3100a-2). While a telephone communication is performed, as illustrated in 3100a-2 of FIG. 31A, in response to detecting a drag upwards along a long side of the folded terminal device 200, the controller 290 may control the speaker 270 to increase a volume of a telephone communication sound (3100a-3).

As another example, in response to receiving a text message while the user terminal device 200 is folded, the controller 290 may control the speaker 270 to output a notification sound which signifies that a message is received (3100b-1). Herein, as illustrated in 3100b-1 FIG. 31B, in response to detecting a tap interaction on a part of the bezel unit 235, the controller 290 may control a text-to-speech (TTS) conversion of the text message and control the speaker to output the converted speech (3100b-2). Also, in response to detecting a drag upwards along a long side of the folded terminal device 200 while an audio corresponding to the text message is being outputted (3100b-2), the controller 290 may control the speaker 270 to increase a volume corresponding to the text message (3100b-3). Although the functions of the folded terminal device 200 have been described with reference to receiving a voice call and receiving a text message, these are merely exemplary, and the terminal device 200 may be configured to perform various functions in accordance with a state of the terminal device.

When the user terminal device 200 is substantially square shaped, the controller 290 may maintain a main control area on a bottom side oriented towards a user so that a user can easily access the main control area even if the user terminal device 200 is rotated.

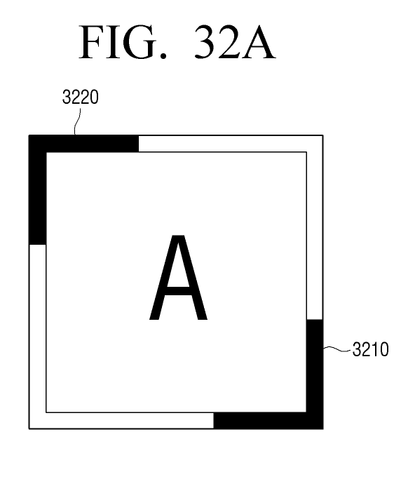

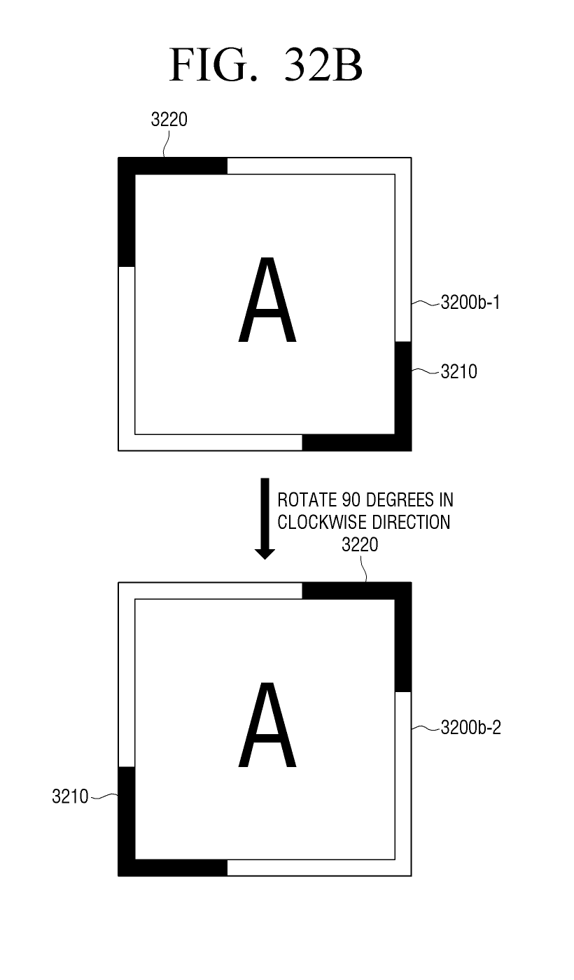

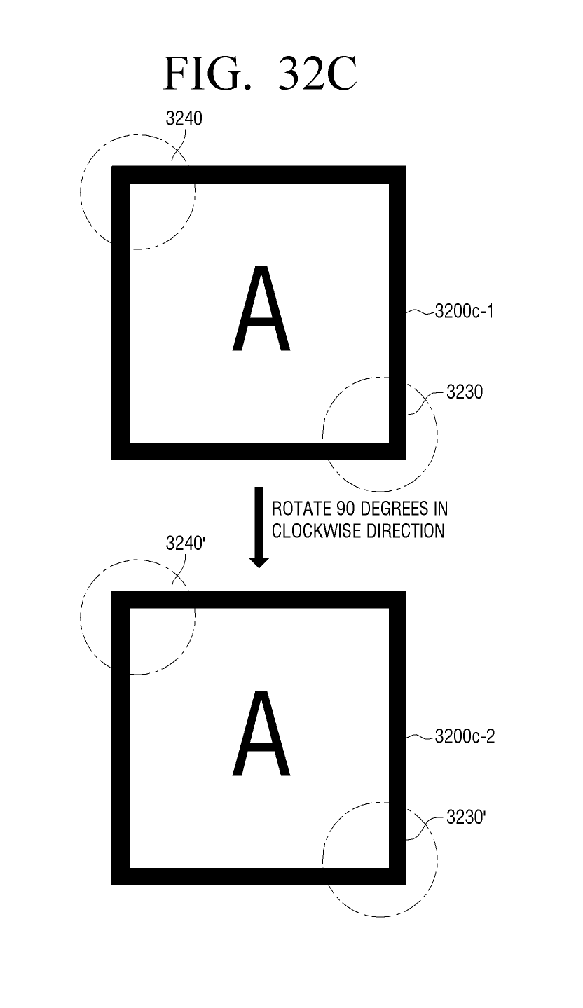

As an exemplary embodiment, as illustrated in FIG. 32A, the second touch detector 282 of the user terminal device 200 may be located on the right-bottom area 3210 and the left-top area 3220 of the bezel unit 235. Herein, in response to detecting a touch interaction on the right-bottom area 3210, the controller 290 may perform a main control function (for example, a home menu call, an application control menu call, and the like). In response to detecting a touch interaction on the left-upper area 3220, the controller 290 may perform a control function (for example, an additional function of an application which is executed currently, and the like).

As illustrated in FIG. 32B, when the second touch detector 282 is located on a right-bottom area 3210 and a left-upper area 3220 (3200b-1), in response to detecting a touch interaction after rotating the user terminal device 200 90 degrees in the clockwise direction, the controller 290 may perform a main control function in response to a touch interaction on the lower-left area 3210, and a sub control function in response to detecting a touch on the right-upper area 3220.

As another example, the second touch detector 282 of the user terminal device 200 may be located on an entire area of the bezel unit 235, as illustrated in 3200c-1 of FIG. 32. Herein, in response to detecting a touch interaction on the right-bottom area 3230, the controller 290 may perform a main control function (for example, a home menu call, an application control menu and the like). Also, in response to detecting a touch interaction on the left-upper area 3240, the controller 290 may perform a sub control function (for example, an additional function of an application which is executed currently).

After the user terminal device 200 is rotated 90 degrees in the clockwise direction (3200c-2), in response to detecting a touch interaction in the right-bottom area 3230′, the controller 290 may perform the main control function, and in response to detecting a touch interaction on the left-upper area 3240′, the controller 290 may perform the sub control function.

In the above exemplary embodiment, even if the user terminal device 200 rotates, a touch area for controlling the main control function may consistently located on a bottom side of the user terminal.

In response to simultaneously detecting a touch interaction on the bezel unit 235 through the second touch detector 282 and a shake interaction which shakes the user terminal interaction 200 through a movement detector 283, the controller 290 may perform a function different from a function in response to only detecting a touch interaction on the bezel unit 235.

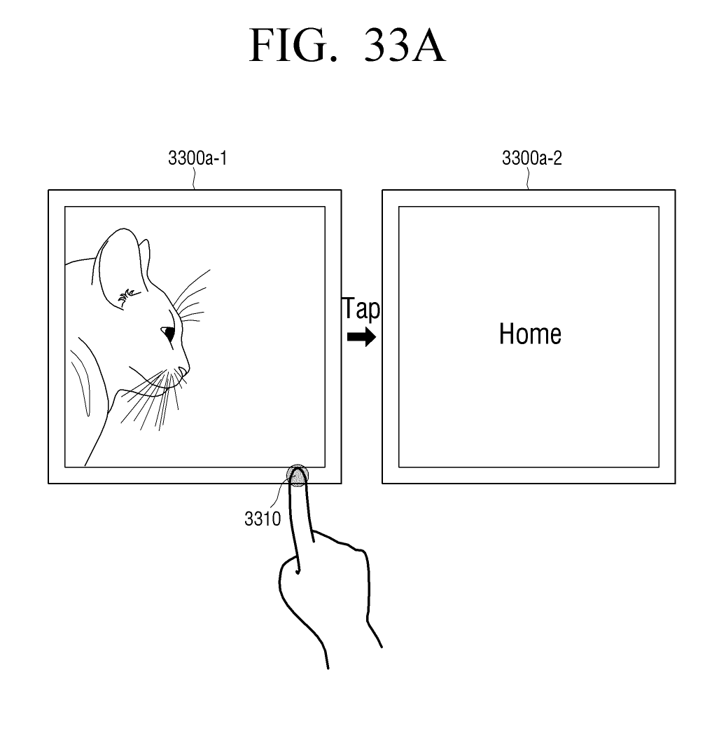

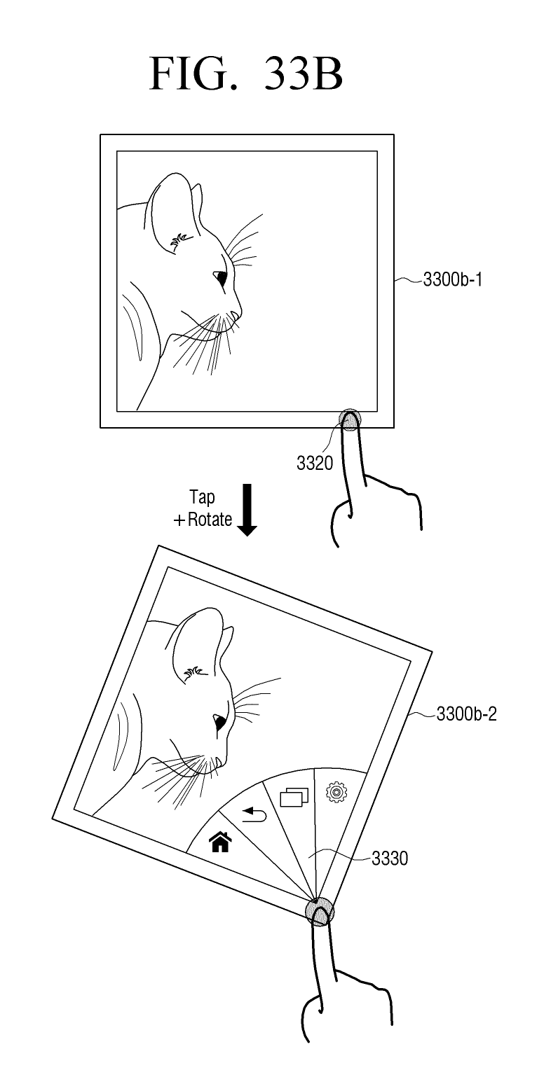

For example, as illustrated in the left side of FIG. 33A, in response to detecting a tap interaction 3310 on bottom side of the bezel unit 235 while a gallery application is displayed (3300a-1), the controller 290 may control the display 230 to convert a current screen to a home screen as illustrated in 3300a-2 of FIG. 33A.

However, as illustrated in the top of FIG. 33B, in response to simultaneously detecting a tap interaction 3320 on a bottom side of the bezel unit 235 and a shake interaction which shakes the user terminal device 200 while a gallery application is displayed (3300b-1), the controller 290 may control the display 230 to display a home menu 3330 including at least one icon corresponding to a corner area proximate to where the tap interaction 3320 is detected as illustrated in 3200b-2 of FIG. 33B. Herein, as illustrated in 3200b-2 of FIG. 33B, the home menu 3330 may include a home screen movement icon, a back icon, an icon for seeing another window, a setting icon and the like.

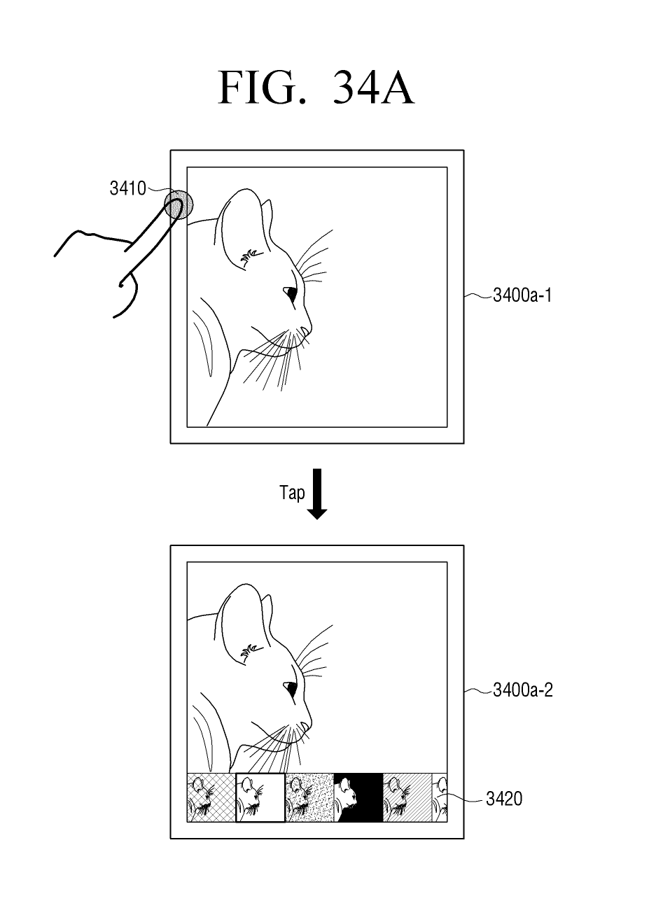

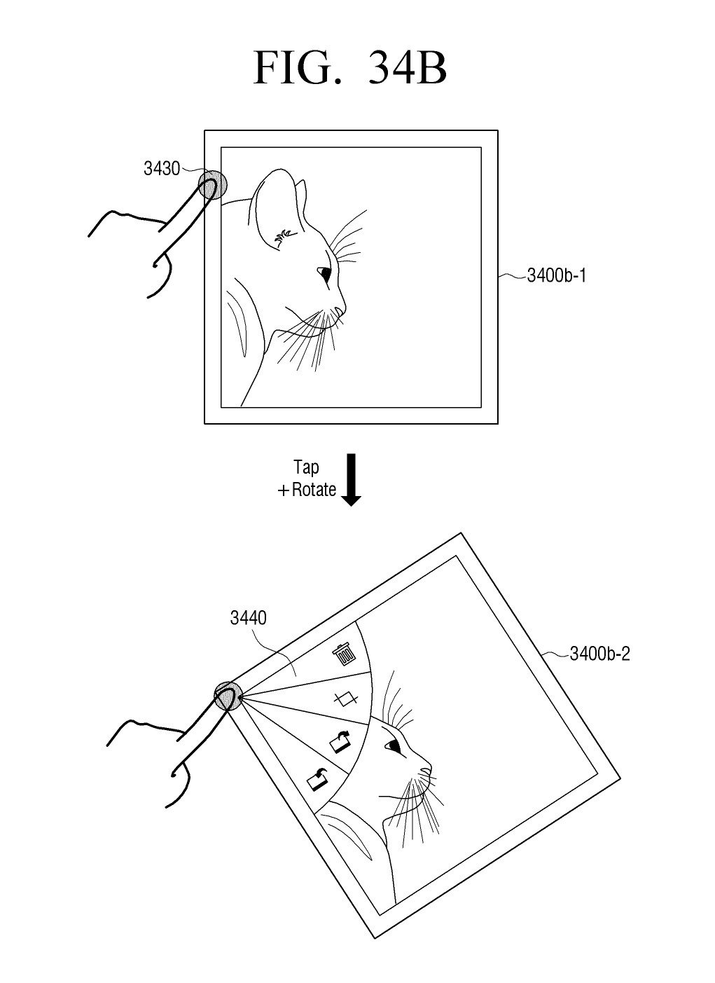

As another example, as illustrated in FIG. 34A, in response to detecting a tap interaction 3410 on an upper left side of the bezel unit 235 while a gallery application is displayed (3400a-1), the controller 290 may control the display 230 to display a plurality of images 3420 where a different attribute value is applied to picture contents displayed in 3400a-2 of the display 230 as illustrated in the bottom of FIG. 34A.

However, as illustrated in FIG. 34B, in response to detecting a tap interaction 3430 on an upper left side of the bezel unit 235 and a shake interaction which shakes the user terminal device 200 while a gallery application is executed (3400b-1), the controller 290 may control the display 230 to display a context menu 3440 including at least an icon to remove a gallery application corresponding to a corner area proximate to where the tap interaction 3430 is detected as illustrated in 3400b-2 of FIG. 34B. Herein, as illustrated in 3400b-2 of FIG. 34B, the context menu 3440 may include an icon for seeing previous picture contents, an icon for seeing next picture contents, an edit icon, a delete icon and the like.

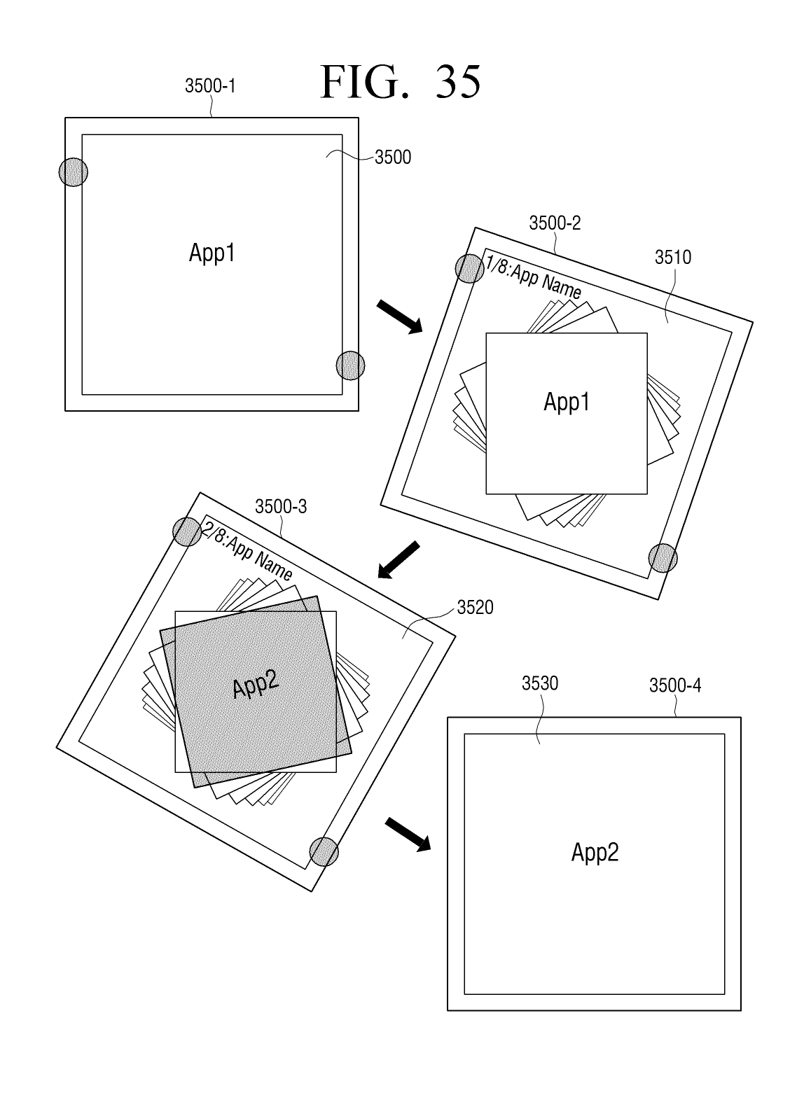

As illustrated in FIG. 35, in response to detecting a shake interaction and simultaneously detecting touches on a left side and on a right side of the bezel unit 235 while a first application 3500 is displayed (3500-1), the controller 290 may control the display to reduce a size of the first application 3500, and to display a screen 3510 where a plurality of applications are stacked as cards as illustrated in the 3500-2 of FIG. 35. As illustrated in 3500-2 of FIG. 35, in response to detecting a shake interaction while simultaneously detecting touches on the left side and the right side of the bezel unit 235 while the screen 3510 where the reduced sized first application and other applications are stacked like cards, the controller 290 may control the display 230 to display a screen 3520 where a second application is located on a top of the stack as illustrated in 3500-3 of FIG. 35. As illustrated in 3500-3 of FIG. 35, while the screen 3520 where the second application is located on top of the stack, if the touch on the left side and the right side of the bezel unit 235 are released, the controller 290 may control the display 230 to display a screen 3530 where the second application is enlarged as an entire screen (3500-4).

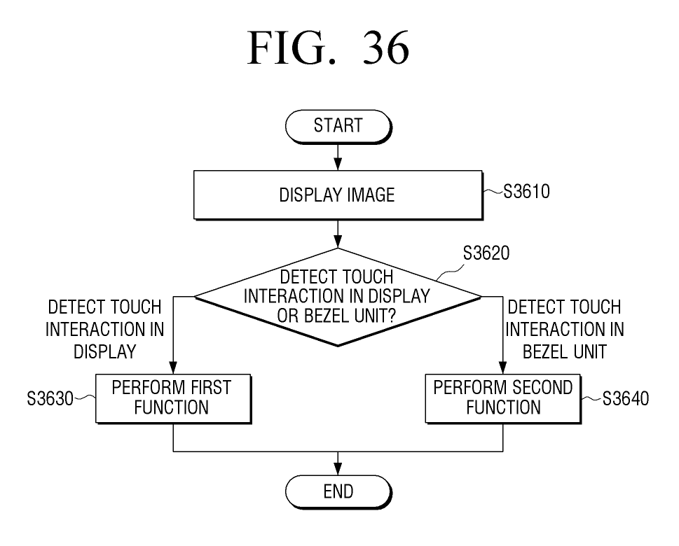

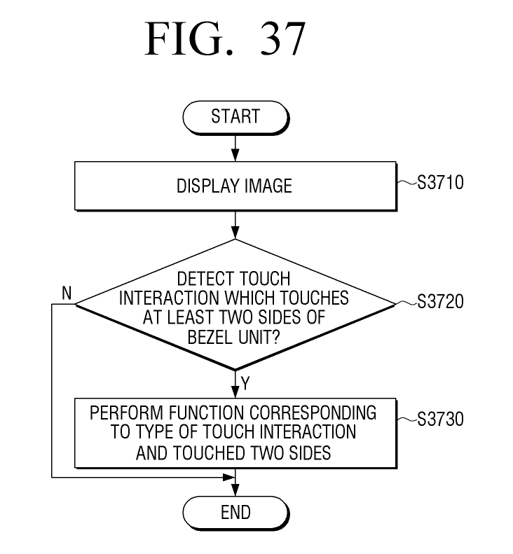

Referring to FIGS. 36 and 37, a method for displaying the user terminal device 200 may be explained according to one or more exemplary embodiments. FIG. 36 is a flowchart describing a method of performing different functions in response to detecting a touch interaction in the display 230 and the bezel unit 235, respectively.

The user terminal device 200 displays an image (S3610).

The user terminal device 200 detects a touch interaction and determines whether the touch interaction is in the display 230 or the bezel unit 235 (S3620). A touch interaction includes at least one of a tap interaction, a drag interaction, a swipe interaction, a pinch interaction, and a multi-touch interaction.

In response to detecting a touch interaction on the display 230, the user terminal device 200 performs the first function (S3630), and in response to detecting a touch interaction in the bezel unit 235, the user terminal device 200 performs the second function (S3640). That is, even if an identical type of touch interaction is inputted to the user terminal device 200, a different function may be performed according to whether the touch interaction is inputted into the display 230 or the bezel unit 235.

FIG. 37 is a flowchart illustrating an exemplary embodiment of a method of performing a function of a user terminal device in response to detecting a touch interaction on a plurality of sides of the bezel unit 235.

The user terminal displays an image (S3710).

The user terminal device 200 determines whether a touch interaction which touches at least two sides of the bezel unit 235 is detected (S3720).

In response to detecting a touch interaction which touches at least two sides of the bezel unit 235 (S3720-Y), the user terminal device 200 performs a function corresponding to a type of the touch interaction and the touched two sides (S3730).

According to various exemplary embodiments described above, a user may perform various functions of the user terminal device 200 by touching at least one of the display 230 and the bezel unit 235.

A method for displaying a user terminal device according to various exemplary embodiments described above may be realized as a program and be provided to the user terminal device. For example, a non-transitory computer readable medium where a program including a method for controlling a user terminal device may be provided.

The non-transitory readable medium means a medium which stores a data semi-permanently and is readable by an apparatus, not a media which stores a data for a short period of time, such as a register, a cache, a memory and so on. For example, a CD, a DVD, a hard disk, a Blu-ray disk, a USB, a memory card and ROM may be the non-transitory readable medium.

Exemplary embodiments of the present invention were illustrated and explained above, but the present invention is not limited to the described exemplary embodiments. Also, the description of the exemplary embodiments of intended to be illustrative, and not to limit the scope of the claims. It would be appreciated by those skilled in the art that changes may be made to the exemplary embodiments without departing from the principles and spirit of the invention, the scope of which is defined in the appended claims.

What is claimed is:

1. A user terminal device comprising:
a display;
a bezel housing the display, the bezel comprising a plurality of sides;
a first touch detector configured to detect a first touch interaction on the display;
a second touch detector configured to detect a second touch interaction on the bezel; and
a controller configured to, in response to the second touch detector detecting the second touch interaction comprising one or more touch inputs on at least two sides of plurality of sides of the bezel, control the user terminal device to perform a function corresponding to a type of the one or more touch inputs and a position of the touched at least two sides.

2. The user terminal device as claimed in claim 1, wherein the controller is further configured to, while an image content is displayed and in response to the second touch detector detecting the second touch interaction comprising a first touch input on a first side of the plurality of sides and, contemporaneously, a second touch input on a second side of the plurality of sides, the second side adjoining the first side, control the display to display information corresponding to the image content on an area of the display corresponding to an area where the first side and the second side adjoin.

3. The user terminal device as claimed in claim 1, wherein the controller is further configured to, in response to the second touch detector detecting the second touch interaction comprising a first touch input onto a first side of the plurality of sides and, contemporaneously, a second touch input onto a second side of the plurality of sides, the second side adjoining the first side, control the display to display notification information corresponding to an area of the display corresponding to an area where the first side and the second side adjoin.

4. The user terminal device as claimed in claim 1, wherein the controller is further configured to, while an execution screen of a first application is displayed on the display and in response to the second touch detector detecting the second touch interaction comprising a first touch input onto a first side of the plurality of sides and, contemporaneously, a second touch input onto a second side of the plurality of sides, the second side adjoining the first side, control the display to divide the display into first and second areas based on a line connecting a location of the first touch input and a location of the second touch input, to display the execution screen of the first application on the first area, and to display an execution screen of a second application on the second area.

5. The user terminal device as claimed in claim 1, wherein the controller is further configured to:
while a picture content is displayed on the display and in response to the second touch detector detecting the second touch interaction comprising a drag input on a first side of the plurality of sides toward a second side of the plurality of sides, the second side adjoining the first side, control the display to display a zoomed-in image of the picture content, and
while a picture content is displayed on the display and in response to the second touch detector detecting the second touch interaction comprising a drag input on the first side toward a third side of the plurality of sides, the third side adjoining the first side at a different location from where the second side adjoins the first side, control the display to display a zoomed-out image of the picture content.

6. The user terminal device as claimed in claim 1, wherein the controller is further configured to, while a picture content is displayed on the display and in response to the second touch detector detecting the second touch interaction comprising a first drag input on a first side of the plurality of sides and, contemporaneously, a second drag input on a second side of the plurality of sides not adjoining the first side, the first and second drag inputs being both in either a clockwise or counter-clockwise direction, control the display to rotate the picture content.

7. The user terminal device as claimed in claim 1, wherein the controller is further configured to, while an execution screen of a first application is displayed and in response to the second touch detector detecting the second touch input comprising a first swipe input on a first side of the plurality of sides and, contemporaneously, a second swipe input on a second side of the plurality of sides, the second side adjoining the first side, control the display to display an execution screen of a second application on a first area of the execution screen of the first application corresponding to the first and second swipe inputs.

8. The user terminal device as claimed in claim 1, wherein the controller is further configured to, while a display screen of the display is divided into first and second areas, where an execution screen of a first application is displayed on the first area and an execution screen of a second application is displayed on the second area, and in response to the second touch detector detecting the second touch interaction comprising a touch input on a first side of the plurality of sides which is adjacent to the first area and a drag input on a second side of the plurality of sides which is adjacent to the second area, control the display to remove the execution screen of the second application from the second area and display on the second area an execution screen of a third application.

9. A displaying method of a user terminal device capable of receiving inputting a touch input on a display and on a bezel which houses the display, the bezel comprising a plurality of sides, the displaying method comprising:
displaying an image on the display; and
performing, in response to detecting a touch interaction comprising one or more touch inputs on at least two sides of the plurality of sides of the bezel unit, a function of the user terminal device corresponding to a type of the one or more touch inputs and a position of the touched at least two sides.

10. The displaying method as claimed in claim 9, wherein the performing comprises displaying, in response to detecting a first touch input on a first side of the plurality of sides and, contemporaneously, a second touch input on a second side of the plurality of sides while an image content is displayed, the second side adjoining the first side, information corresponding to the image content on an area of the display corresponding to an area where the first side and the second side adjoin.

11. The displaying method as claimed in claim 9, wherein the performing comprises displaying, in response to detecting a first touch input on a first side of the plurality of sides and, contemporaneously a second touch input on a second side of the plurality of sides, the second side adjoining the first side, notification information corresponding to an area of the display corresponding to an area where the first side and the second side adjoin.

12. The displaying method as claimed in claim 9, wherein the performing comprises, in response to detecting a first touch input on a the first side of the plurality of sides and, contemporaneously, a second touch input on a second side of the plurality of sides while a first application is executed, the second side adjoining the first side, dividing the display into first and second areas based on a line connecting a location of the first touch input and a location of the second touch input, displaying an execution screen of the first application on the first area, and displaying an execution screen of a second application on the second area.

13. The displaying method as claimed in claim 9, wherein the performing comprises, in response to detecting a drag input on a first side of the plurality of sides toward a second side of the plurality of sides, the second side adjoining the first side, while a picture content is displayed, zooming-in the picture content, and
in response to detecting a drag input on the first side toward a third side of the plurality of sides, the third side adjoining the first side at a different location from where the second side adjoins the first side while a picture content is displayeds, zooming-out the picture content.

14. The displaying method as claimed in claim 9, wherein the performing comprises, in response to detecting a drag input on a first side of the plurality of sides and, contemporaneously, a second drag input on a second side of the plurality of sides not adjoining the first side while a picture content is displayed, the first and second drag inputs being both in either a clockwise or counter-clockwise direction, rotating the picture content.

15. The displaying method as claimed in claim 9, wherein the performing comprises, in response to detecting a swipe input on a first side of the plurality of sides and, contemporaneously, a second swipe input on a second side of the plurality of sides while a first application is executed, the second side adjoining the first side, displaying an execution screen of a second application on a first area of an execution screen of the first application of the first application corresponding to the first and second swipe inputs.

16. The displaying method as claimed in claim 9, wherein the performing comprises, while a display screen of the display is divided into first and second areas, where an execution screen of a first application is displayed on the first area and an execution screen of a second application is displayed on the second area, and in response to detecting a touch input on a first side of the plurality of sides which is adjacent to the first area and a drag input on a second side of the plurality of sides which is adjacent to the second area, removing the execution screen of the second application from the second area and displaying an execution screen of a third application.

17. A user terminal device comprising:
a display;
a bezel housing the display, the bezel comprising a plurality of sides;
a first touch detector configured to detect a first touch interaction on the display;
a second touch detector configured to detect a touch interaction on the bezel; and
a controller configured to, in response to the first touch detector detecting the first touch interaction comprising a first touch input on the display, control the user terminal device to perform a first function, and, in response to the second touch detector detecting the second touch interaction comprising a second touch input on the bezel, the second touch input being of a same type as the first touch input, control the user terminal device to perform a second function.

18. The user terminal device as claimed in claim 17, wherein the controller is further configured to, while an image displayed on an execution screen of a gallery application is displayed on the display, in response to the first touch detector detecting the first touch interaction comprising a drag input on the display, control the display to change the displayed execution screen based on a file unit, and, in response to the second touch detector detecting the second touch interaction comprising a drag input on the bezel, control the display to change the displayed execution screen based on a folder unit.

19. The user terminal device as claimed in claim 17, wherein the controller is further configured to, while an execution screen of an e-book application is displayed, in response to the first touch detector detecting the first touch interaction comprising a drag input on the display, control the display to change the displayed execution screen based on a page unit, and, in response to the second touch detector detecting the second touch interaction comprising a drag input on the bezel, control the display to change the displayed execution screen based on a chapter unit.

20. The user terminal device as claimed in claim 17, wherein the controller is further configured to, while an execution screen of a first application is displayed on a display screen if the display, in response to the first touch detector detecting the first touch interaction comprising a drag input on the display, control the display to scroll the execution screen of the first application, and, in response to the second touch detector detecting the second touch interaction comprising a drag input on the bezel, control the display to remove a portion of the execution screen of the first application from a portion of the display screen and display a portion of an execution screen of a second application on the portion of the display screen.
